(19) United States
(12) Patent Application Publication
(10) Pub. No.: US 2007/0181507 A1
(43) Pub. Date: Aug. 9, 2007

(54) Fluid handling apparatus

(75) Inventor: Takuhito Ohse, Saitama-shi (JP)

Correspondence Address: BACHMAN & LAPOINTE, P.C., 900 CHAPEL STREET, SUITE 1201, NEW HAVEN, CT, 06510, US

(73) Assignee: Enplas Corporation

(21) Appl. No.: 11/703,039

(22) Filed: Feb. 5, 2007

(30) Foreign Application Priority Data
Feb. 9, 2006 (JP) 2006-032338

(51) Int. Cl. C02F 1/00

(52) U.S. Cl. 210/744

(57) ABSTRACT

A fluid handling apparatus 10 has an upper apparatus body 12 on which a plurality of upper fluid handling sections 16 are arrayed, and a lower apparatus body 14 capable of mounting thereon the upper apparatus body 12. Each of the upper fluid handling sections 16 of the upper apparatus body 12 has an upper fluid handling chamber 28 in which a large number of beads 24 are housed, and a valve body 26 which is provided in the bottom portion of the upper fluid handling chamber 28, the valve body 26 being pushed up by a protruding portion 18b when the upper apparatus body 12 is mounted on the lower apparatus body 14.

### BACKGROUND OF THE INVENTION

1. Field of the Invention

The present invention generally relates to a fluid handling apparatus. More specifically, the invention relates to a fluid handling apparatus capable of being used as a sample analyzing apparatus for analyzing samples, such as biosubstances representative of functional substances.

2. Description of the Prior Art

As conventional methods for specifically detecting biosubstances, such as proteins, there are known various methods for causing an antigen-antibody reaction using an antibody to a specific biosubstance, to carry out the visual recognition or spectroscopic measurement of a reactant thus obtained, to detect the biosubstance.

As methods for quantifying a reactant obtained by an antigen-antibody reaction of a biosubstance, such as a protein, there are widely adopted some methods, such as ELISA (Enzyme-Linked ImmunoSorbent Assay). In these methods, there is used a sample analyzing apparatus called a microplate wherein a large number of fine recessed portions generally called microwells (which will be hereinafter referred to as “wells”) are arrayed. The wall surfaces of the wells are coated with an antibody to a specific biosubstance, which is a target substance, as a capturing (or catching) material, to capture (or catch) the target substance by the capturing material to detect the target substance by measuring a reactant, which is obtained by an antigen-antibody reaction between the target substance and the antibody, by fluorescence, luminous reagents or the like.

In a typical method using a microplate, such as ELISA, a well is filled with a liquid, such as a specimen containing a target substance or an antibody reagent, as a reaction solution to cause a reaction. This reaction does not occur until the components in the liquid filled in the well are moved by molecular diffusion to reach the bottom and inner walls of the well. For that reason, if a microplate is allowed to stand, a theoretical reaction time depends on the diffusion time of the components in the liquid filled in the well. Since the molecules in the liquid move while colliding with the surrounding molecules, the speed of diffusion is very slow. If the target substance is a protein having a molecular weight of about 70,000, the speed of diffusion is about 0.5 to 1×10⁻⁶ cm²/sec in a dilute aqueous solution (room temperature). Therefore, in the liquid filled in the well, the target substance located apart from the bottom and inner walls of the well is hardly allowed to react in a practical measuring time. In addition, since it is effective to cause the bottom and wall surfaces in the well serving as a reacting portion to uniformly contact the reaction solution in order to improve the efficiency of reaction in a microplate, it is required to use a larger quantity of liquid than the quantity of liquid required for the reaction.

Thus, in the conventional method using the microplate, such as ELISA, the antigen-antibody reaction proceeds only on the wall surface of the well coated with the capturing antibody. Therefore, the liquid must be allowed to stand until the reaction occurs after the target substance, antibody and substrate contained in the liquid fed into the well are suspended, circulated and sink in the well to reach the wall surface of the well, so that there is a problem in that the efficiency of reaction is bad. In addition, in a microplate which is subdivided into a large number of wells, the quantity of liquid fed into each of the wells is limited, so that there is a problem in that the sensitivity of measurement is deteriorated.

There is known a method using a porous material as a capturing material as a method for improving the efficiency of reaction and the sensitivity of measurement. However, it is required to provide an external power, such as a pump, in order to control the flowability of liquid, and it is difficult to continuously control the flowability of liquid since the porous material is easily clogged up. There is also known a method for fluidizing liquid by pressurization or suction as a method using a microchip having a fine space to fluidize liquid in the fine space. However, it is also required to provide an external power and a complicated device in this method. Moreover, there is known a method using a microchip having a fine space to fluidize liquid in the fine space by a valve structure. However, it is also required to provide power or energy for operating the valve in this method.

When a sample is analyzed by ELISA, it is required to cause a plurality of antigen-antibody reactions. It takes one hour or more to cause each of the antigen-antibody reactions, and it is required to wash the wells between the antigen-antibody reactions, so that it is required to repeatedly carry out the injecting operation of liquid into the wells and the discharging operation of liquid from the wells. There are some cases where it is required to wash injecting nozzles for injecting liquid into the wells. Thus, when a sample is analyzed by ELISA, it takes a lot of time, and it is required to carry out many operations. As methods for improving such problems, there are proposed methods for forming wells, the bottom of each of which is made of a porous film, to discharge liquid below the wells by pressure (see, e.g., Japanese Patent Unexamined Publication No. 9-504864 (National Publication of Translated Version of PCT/US94/12282) and Japanese Patent Laid-Open No. 2004-45197).

However, in the methods proposed in Japanese Patent Unexamined Publication No. 9-504864 and Japanese Patent Laid-Open No. 2004-45197, it is required to provide an external power, such as a pump, for discharging liquid, and a complicated device. In addition, it is difficult for the bottom of each of the wells to be a light permeable bottom, so that the methods can not be applied to the absorbance measuring method which is the most typical detecting method in ELISA or the like.

### SUMMARY OF THE INVENTION

It is therefore an object of the present invention to eliminate the aforementioned problems and to provide a fluid handling apparatus which is capable of improving the efficiency of reaction and the sensitivity of measurement with a simple structure and of shortening a reaction time and a measuring time, and which is capable of discharging liquid with a simple structure and of being applied to the absorbance measuring method, when the apparatus is used as a sample analyzing apparatus for measuring a large number of specimens.

In order to accomplish the aforementioned and other objects, according to one aspect of the present invention, a fluid handling apparatus comprises an upper apparatus body on which a plurality of upper fluid handling sections are arrayed, and a lower apparatus body for mounting thereon the upper apparatus body, each of the upper fluid handling sections comprising: an inlet for injecting a fluid; an upper fluid handling chamber for housing therein the fluid injected from the inlet; a surface-area increasing means (e.g., a large number of fine particles, or a single member such as a water absorptive member), arranged in the upper fluid handling chamber, for increasing an area of a contact surface with the fluid in the upper fluid handling chamber; an outlet for discharging the fluid downwards from the upper fluid handling chamber; and a valve body for opening and closing the outlet, wherein the lower apparatus body has a lower fluid housing section for housing there in the fluid discharged from the upper fluid handling chamber, and the valve body of each of the upper fluid handling sections is open when the upper apparatus body is mounted on the lower apparatus body. In this fluid handling apparatus, the lower apparatus body preferably has a plurality of protruding portions which protrude upwards from the bottom face of the lower fluid housing section thereof and which are arranged so as to correspond to the upper fluid handling sections, the valve body being pushed up by a corresponding one of the protruding portions when the upper apparatus body is mounted on the lower apparatus body. Each of the upper fluid handling sections preferably has a holding member having an opening for inhibiting the surface-area increasing means from passing therethrough and for allowing the fluid to pass therethrough, the holding member being arranged between the surface-area increasing means and the valve body.

In the above described fluid handling apparatus, the upper fluid handling chamber of each of the upper fluid handling sections may be divided into a first upper fluid handling chamber, which houses therein the surface-area increasing means, and a second upper fluid handling chamber in which the valve body is mounted, the holding member being arranged between the first and second upper fluid handling chambers.

In the above described fluid handling apparatus, the lower fluid handling section of the lower apparatus body preferably has a plurality of lower fluid handling chambers which are separated from each other so that each of the lower fluid handling chambers corresponds to a corresponding one of the upper fluid handling chambers of the upper fluid handling sections. In this case, the holding member is preferably arranged above the valve body to support thereon the surface-area increasing means.

In the above described fluid handling apparatus, an outlet for discharging the fluid is preferably formed in a bottom face of the lower fluid housing section of the lower apparatus body, and the valve body is preferably made of a transparent member.

According to the present invention, it is possible to provide a fluid handling apparatus which is capable of improving the efficiency of reaction and the sensitivity of measurement with a simple structure and of shortening a reaction time and a measuring time, and which is capable of discharging liquid with a simple structure and of being applied to the absorbance measuring method, when the apparatus is used as a sample analyzing apparatus for measuring a large number of specimens. If an outlet for discharging liquid is formed in the bottom of the lower fluid housing section of the lower apparatus body of the fluid handling apparatus, it is possible to easily discharge liquid without using any nozzles in a washing process.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a perspective view of the first preferred embodiment of a fluid handling apparatus according to the present invention;

FIG. 2A is an enlarged plan view of an upper fluid handling section of the fluid handling apparatus of FIG. 1;

FIG. 2B is a sectional view taken along line IIB-IIB of FIG. 2A;

FIG. 2C is a bottom view of the upper fluid handling section of FIG. 2A;

FIG. 2D is a plan view of the upper fluid handling section of FIG. 2A, except for beads;

FIG. 2E is a plan view of the upper fluid handling section of FIG. 2D, except for a mesh member;

FIG. 2F is a plan view of the upper fluid handling section of FIG. 2E, except for a valve body;

FIG. 3A is a perspective view of a valve body for use in the upper fluid handling section of FIG. 2A;

FIG. 3B is a side view of the valve body of FIG. 3A;

FIG. 3C is a plan view of the valve body of FIG. 3A;

FIG. 3D is a bottom view of the valve body of FIG. 3A;

FIG. 3E is a sectional view taken along line IIIE-IIIE of FIG. 3C;

FIG. 4 is a perspective view for explaining a method for assembling the upper fluid handling section of FIG. 2A;

FIG. 5A is an enlarged plan view of a lower fluid handling section of the fluid handling apparatus of FIG. 1;

FIG. 5B is a sectional view taken along line VB-VB of FIG. 5A;

FIG. 6 is a sectional view for explaining a state that the upper fluid handling section of FIG. 2A is mounted on the lower fluid handling section of FIG. 5A to open the valve body;

FIGS. 7A through 7E are views for explaining an example of application of the first preferred embodiment of a fluid handling apparatus according to the present invention;

FIG. 8 is a perspective view of the second preferred embodiment of a fluid handling apparatus according to the present invention;

FIG. 9A is an enlarged plan view of an upper fluid handling section of the fluid handling apparatus of FIG. 8;

FIG. 9B is a sectional view taken along line IXB-IXB of FIG. 9A;

FIG. 9C is a bottom view of the upper fluid handling section of FIG. 9A;

FIG. 9D is a side view of the upper fluid handling section of FIG. 9A;

FIG. 10A is a perspective view of a valve body for use in the upper fluid handling section of FIG. 9A;

FIG. 10B is a side view of the valve body of FIG. 10A;

FIG. 10C is a plan view of the valve body of FIG. 10A;

FIG. 10D is a bottom view of the valve body of FIG. 10A;

FIG. 10E is a sectional view taken along line XE-XE of FIG. 10C;

FIG. 11 is a perspective view for explaining a method for assembling the upper fluid handling section of FIG. 9A;

FIG. 12A is an enlarged plan view of a lower fluid handling section of the fluid handling apparatus of FIG. 8;

FIG. 12B is a sectional view taken along line XIIB-XIIB of FIG. 12A;

FIG. 13 is a perspective view for explaining a state that the upper fluid handling section of FIG. 9A is to be mounted on the lower fluid handling section of FIG. 12A;

FIG. 14 is a sectional view for explaining a state that the upper fluid handling section of FIG. 9A is mounted on the lower fluid handling section of FIG. 12A to open the valve body;

FIGS. 15A through 15E are views for explaining an example of application of the second preferred embodiment of a fluid handling apparatus according to the present invention;

FIG. 16 is a perspective view of the third preferred embodiment of a fluid handling apparatus according to the present invention;

FIG. 17A is an enlarged plan view of an upper fluid handling section of the fluid handling apparatus of FIG. 16;

FIG. 17B is a sectional view taken along line XVIIB-XVIIB of FIG. 17A;

FIG. 17C is a bottom view of the upper fluid handling section of FIG. 17A;

FIG. 17D is a side view of the upper fluid handling section of FIG. 17A;

FIG. 18 is a perspective view for explaining a method for assembling the upper fluid handling section of FIG. 17A;

FIG. 19A is an enlarged plan view of a part of a lower apparatus body of the fluid handling apparatus of FIG. 16;

FIG. 19B is a sectional view taken along line XIXB-XIXB of FIG. 19A;

FIG. 20 is a perspective view for explaining a state that the upper fluid handling section of FIG. 17A is to be mounted on the lower fluid handling section of FIG. 19A;

FIG. 21 is a sectional view for explaining a state that the upper fluid handling section of FIG. 17A is mounted on the lower fluid handling section of FIG. 19A to open the valve body;

FIGS. 22A through 22F are views for explaining an example of application of the third preferred embodiment of a fluid handling apparatus according to the present invention;

FIG. 23A is a plan view of the fourth preferred embodiment of a fluid handling apparatus according to the present invention;

FIG. 23B is a plan view of a lower apparatus body of the fluid handling apparatus of FIG. 23A;

FIG. 24A is an enlarged plan view of an upper fluid handling section of the fluid handling apparatus of FIG. 23A;

FIG. 24B is a sectional view taken along line XXIVB-XXIVB of FIG. 24A;

FIG. 24C is a side view of the upper fluid handling section of FIG. 24A;

FIG. 25A is a perspective view of a valve body for use in the upper fluid handling section of FIG. 24A;

FIG. 25B is a plan view of the valve body of FIG. 25A;

FIG. 25C is a sectional view taken along line XXVC-XXVC of FIG. 25B;

FIG. 26 is a perspective view for explaining a method for assembling the upper fluid handling section of FIG. 24A;

FIG. 27A is an enlarged plan view of a part of the lower apparatus body of FIG. 23B;

FIG. 27B is a sectional view taken along line XXVIIB-XXVIIB of FIG. 27A;

FIG. 28 is a perspective view for explaining a state that the upper fluid handling section of FIG. 24A is to be mounted on the lower fluid handling section of FIG. 27A;

FIG. 29 is a sectional view for explaining a state that the upper fluid handling section of FIG. 24A is mounted on the lower fluid handling section of FIG. 27A to open the valve body;

FIG. 30 is a perspective view of a lower apparatus body used as an exclusive tray for drain in the fifth preferred embodiment of a fluid handling apparatus according to the present invention;

FIG. 31A is an enlarged plan view of a part of the lower apparatus body of FIG. 30;

FIG. 31B is a sectional view taken along line XXXIB-XXXIB of FIG. 31A;

FIG. 32 is a perspective view for explaining a state that the upper fluid handling section of FIG. 2A is to be mounted on the lower apparatus body of FIG. 30;

FIG. 33 is a sectional view for explaining a state that the upper fluid handling section of FIG. 2A is mounted on the lower apparatus body of FIG. 30 to open a valve body;

FIG. 34 is a view for explaining an example of application of the fifth preferred embodiment of a fluid handling apparatus according to the present invention;

FIG. 35 is a perspective view of a lower apparatus body used as an exclusive tray for drain in the sixth preferred embodiment of a fluid handling apparatus according to the present invention;

FIG. 36A is an enlarged plan view of a part of the lower apparatus body of FIG. 35;

FIG. 36B is a sectional view taken along line XXXVIB-XXXVIB of FIG. 36A;

FIG. 37 is a perspective view for explaining a state that the upper fluid handling section of FIG. 9A is to be mounted on the lower apparatus body of FIG. 35;

FIG. 38 is a sectional view for explaining a state that the upper fluid handling section of FIG. 9A is mounted on the lower apparatus body of FIG. 35 to open a valve body;

FIG. 39 is a view for explaining an example of application of the sixth preferred embodiment of a fluid handling apparatus according to the present invention;

FIG. 40A is a perspective view of a water absorptive member capable of being used in place of beads in the first through third, fifth and sixth preferred embodiments of a fluid handling apparatus according to the present invention; and

FIG. 40B is a perspective view of a water absorptive member capable of being used in place of beads in the fourth preferred embodiment of a fluid handling apparatus according to the present invention.

### DESCRIPTION OF THE PREFERRED EMBODIMENTS

Referring now to the accompanying drawings, the preferred embodiments of a fluid handling apparatus according to the present invention will be described below in detail. For example, the preferred embodiments of a fluid handling apparatus according to the present invention can be used as an apparatus for analyzing a sample containing a biosubstance, such as a protein, which is representative of functional substances. In general, the fluid handling apparatus can be used as a sample analyzing apparatus called a microwell plate for carrying out the measurement of a large number of specimens.

### First Preferred Embodiment

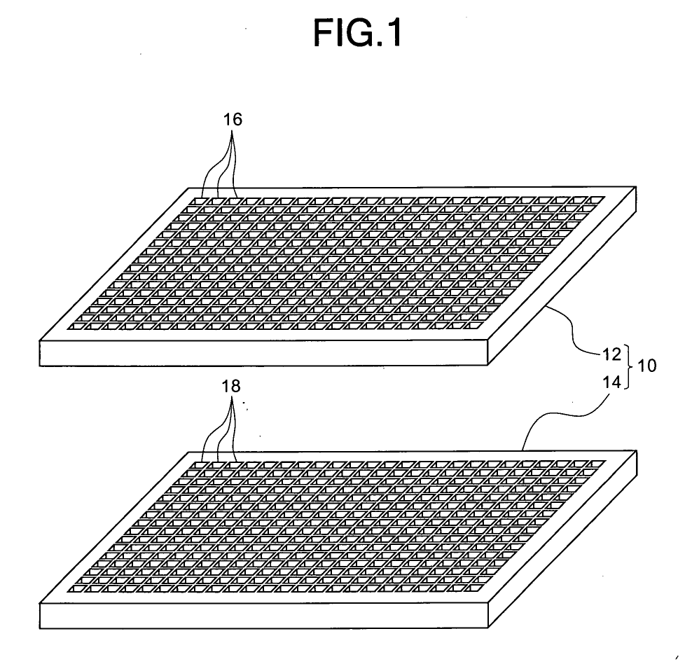

FIGS. 1 through 7E show the first preferred embodiment of a fluid handling apparatus according to the present invention. As shown in FIG. 1, the fluid handling apparatus 10 in this preferred embodiment comprises an upper apparatus body 12 and a lower apparatus body 14. Each of the upper apparatus body 12 and the lower apparatus body 14 comprises a substantially rectangular flat plate member which is made of a resin material, such as polycarbonate (PC) or polymethyl methacrylate (PMMA), or a glass material and which has a thickness of a few millimeters, the length of each side of the flat plate member being in the range of from a few centimeters to over ten centimeters. The upper apparatus body 12 has a large number of upper fluid handling sections 16 (384(=16×24) upper fluid handling sections in this preferred embodiment), which are arrayed thereon, each of the upper fluid handling sections 16 having a substantially square opening in the upper end thereof. On the other hand, the lower apparatus body 14 has a large number of lower fluid handling sections 18 (384(=16×24) lower fluid handling sections in this preferred embodiment), which are arrayed thereon so that each of the lower fluid handling sections 18 corresponds to a corresponding one of the upper fluid handling sections 16, each of the lower fluid handling sections 18 having a substantially square opening in the upper end thereof.

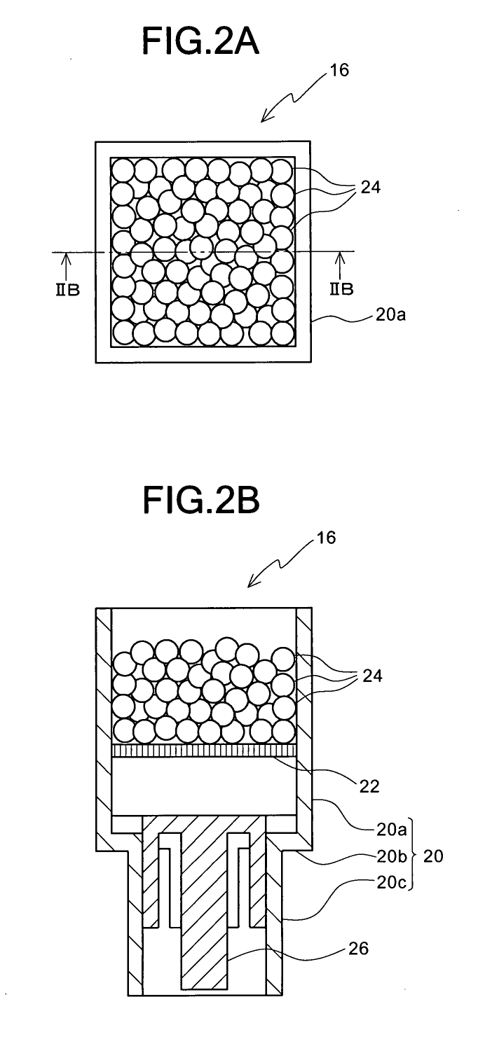

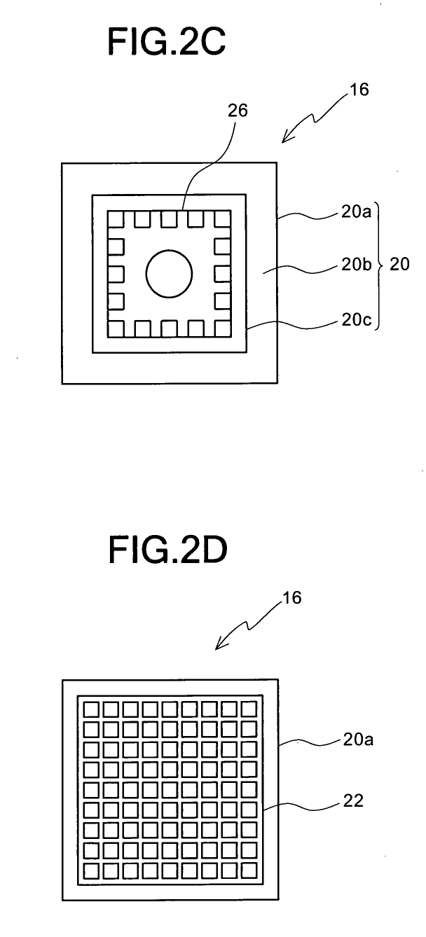

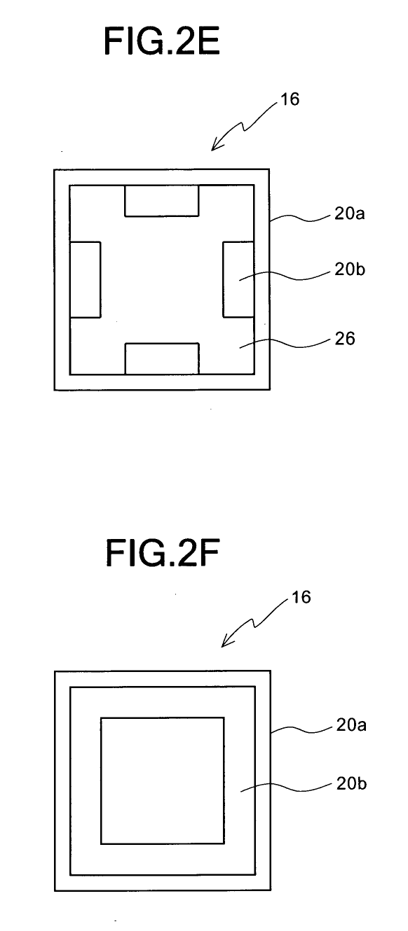

FIGS. 2A through 2F are enlarged views showing one of the upper fluid handling sections 16 of the upper apparatus body 12 of the fluid handling apparatus 10 in this preferred embodiment. FIG. 2A is a plan view of the upper fluid handling section 16, and FIG. 2B is a sectional view taken along line IIB-IIB of FIG. 2A. FIG. 2C is a bottom view of the upper fluid handling section 16, and FIG. 2D is a plan view of the upper fluid handling section 16 of FIG. 2A, except for beads 24. FIG. 2E is a plan view of the upper fluid handling section 16 of FIG. 2D, except for a mesh member 22, and FIG. 2F is a plan view of the upper fluid handling section 16 of FIG. 2E, except for a valve body 26. As shown in FIGS. 2A through 2F, the upper fluid handling section 16 comprises an external wall portion 20, a mesh member 22 mounted in a space defined by the external wall portion 20, a large number of beads 24 filled on the mesh member 22 in the space defined by the external wall portion 20, and a valve body 26 mounted below the mesh member 22 in the space defined by the external wall portion 20.

The external wall portion 20 comprise: an upper vertical wall portion 20a which has a substantially square opening in the upper end thereof and which defines therein a space having a shape of substantially rectangular parallelopiped, each of the length, width and height of the space being a few millimeters; a horizontal wall portion 20b which extends inwardly in horizontal directions from the lower end of the upper vertical wall portion 20a and which extends along the lower end of the upper vertical wall portion 20a to form a substantially square opening which is smaller than the opening formed in the upper end of the upper vertical wall portion 20a; and a lower vertical wall portion 20c which extends downwards in vertical directions from the opening end portion (inner peripheral portion) of the opening of the horizontal wall portion 20b to define therein a space having a shape of substantially rectangular parallelopiped and which forms a substantially square opening in the lower end thereof, the opening formed in the lower end of the lower vertical wall portion 20c being smaller than the opening formed in the upper end of the upper vertical wall portion 20a.

The mesh member 22 is a substantially square mesh member (a member having a mesh structure) which allows fluid to pass therethrough and which inhibit the beads 24 from passing therethrough, the mesh member 22 having a large number of smaller openings than the diameter of each of the beads 24. The mesh member 22 is arranged in the space, which is defined by the upper vertical wall portion 20a, so as to be substantially perpendicular to the upper vertical wall portion 20a, i.e., substantially parallel to the opening formed in the upper end of the upper vertical wall portion 20a. The peripheral portion of the mesh member 22 contacts a lower portion of the inner surface of the upper vertical wall portion 20a than the substantially central portion thereof in vertical directions to be fixed thereto. On the mesh member 22 thus fixed, the large number of beads 24 are filled.

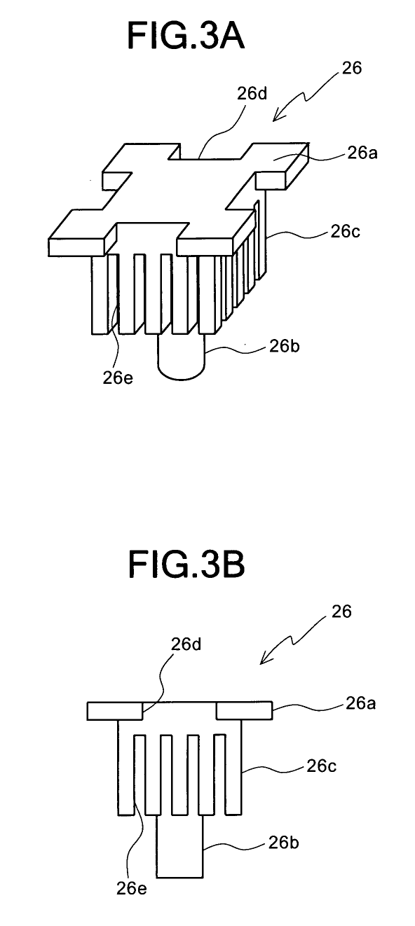

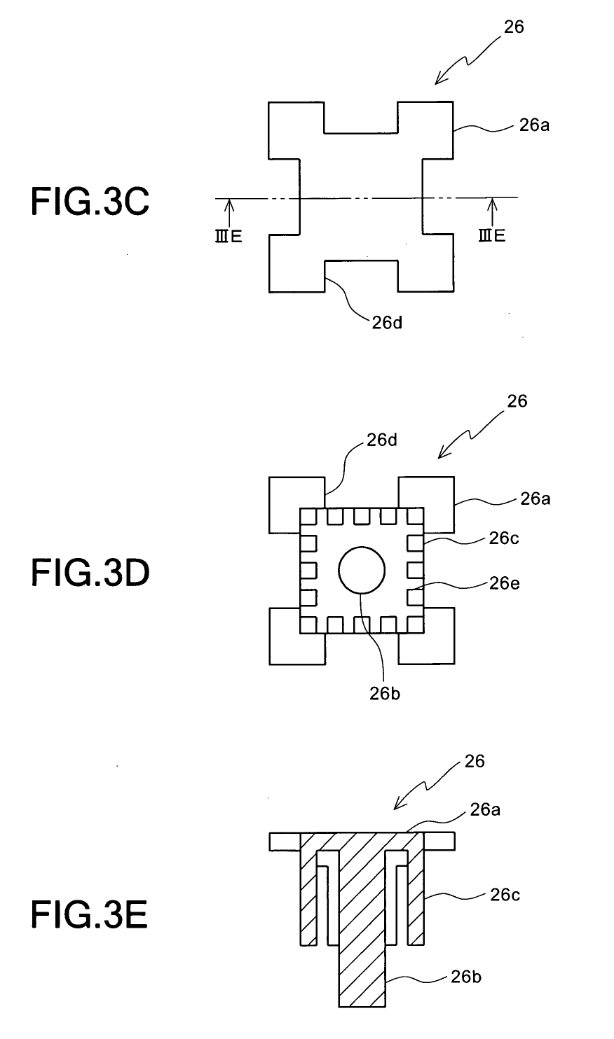

FIGS. 3A through 3E are enlarged views showing a valve body 26 for use in the upper fluid handling section 16 of the upper apparatus body 12 of the fluid handling apparatus 10 in this preferred embodiment. FIG. 3A is a perspective view of the valve body 26, and FIG. 3B is a side view of the valve body 26. FIG. 3C is a plan view of the valve body 26, and FIG. 3D is a bottom view of the valve body 26, FIG. 3E being a sectional view taken along line IIIE-IIIE of FIG. 3C. The valve body 26 is integrally formed of a resin material or the like. As shown in FIGS. 3A through 3E, the valve body 26 comprises: a flat-plate-shaped valve seat horizontal portion 26a; a cylindrical valve rod portion 26b which extends downwards in vertical directions from the central portion of the bottom face of the valve seat horizontal portion 26a; and a valve seat vertical portion 26c which extends downward in vertical directions from the bottom face of the valve seat horizontal portion 26a so as to surround the valve rod portion 26b. The valve seat horizontal portion 26a substantially has the same planar shape as the opening formed in the upper end of the upper vertical wall portion 20a of the external wall portion 20, except that each of substantially rectangular cut-out portions 26d is formed in the substantially central portion of a corresponding one of four side faces thereof. The valve seat vertical portion 26c extends along the four side faces of the valve seat horizontal portion 26a, and the outer surface thereof is arranged on the same plane as the bottom face (extending along each of the side faces of the valve seat horizontal portion 26a) of each of the cut-out portions 26d. Each of the four side faces of the valve seat vertical portion 26c has a plurality of slits 26e (four slits in this preferred embodiment) which extend downwards in vertical directions and which pass through the valve seat vertical portion 26c. Furthermore, a plurality of grooves extending downwards in vertical directions without passing through the valve seat vertical portion 26c may be formed in place of the slits 26e.

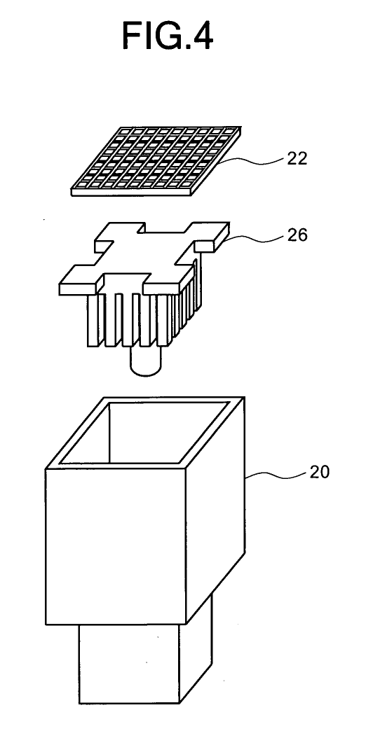

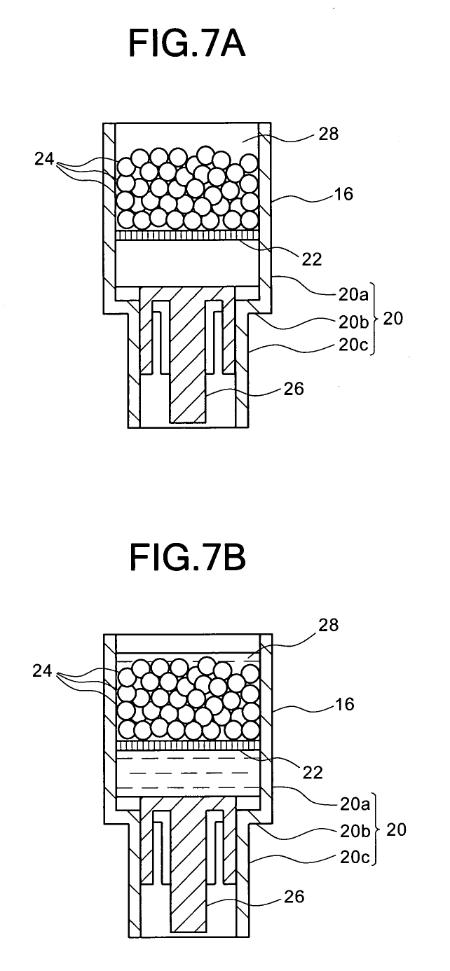

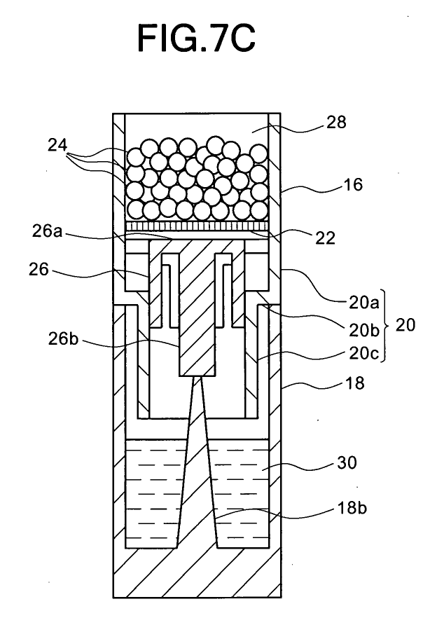

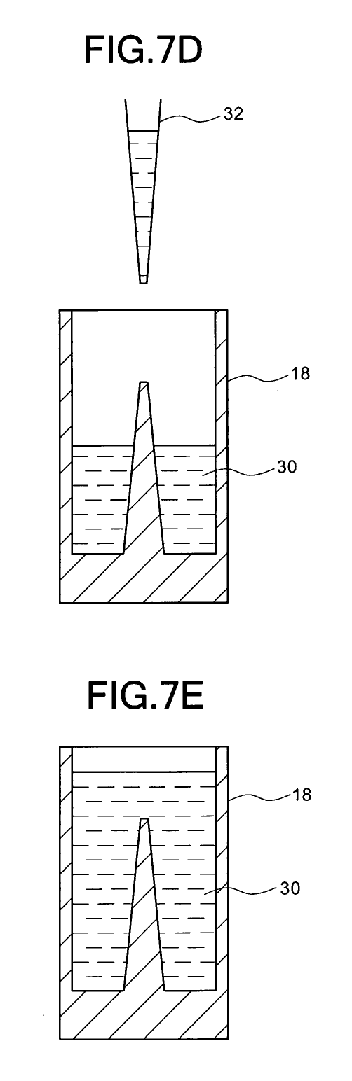

In order to assemble the upper fluid handling section 16 with this construction, as shown in FIG. 4, after the valve body 26 is first inserted into the space defined by the external wall portion 20, the mesh member 22 is inserted into the space defined by the external wall portion 20 to be fixed to the inner surface thereof with an adhesive or the like, and thereafter, the large number of beads 24 are filled on the mesh member 22 in the space defined by the external wall portion 20. The height of the mesh member 22 is set so that the valve body 26 can move upwards to be fully open. If the upper fluid handling section 16 is thus assembled, the opening formed in the upper end of the external wall portion 20 can be used as an inlet for injecting a fluid, such as a liquid sample, and a space serving as an upper fluid handling chamber 28 (see FIG. 7A) is formed above the valve body 26 in the space defined by the external wall portion 20 when the valve body 26 is arranged at the lower end thereof (when the valve is closed). Below the upper fluid handling chamber 28, a communication passage for feeding a fluid into the lower fluid handling section 18 is formed when the valve body 26 moves upwards (when the valve is open).

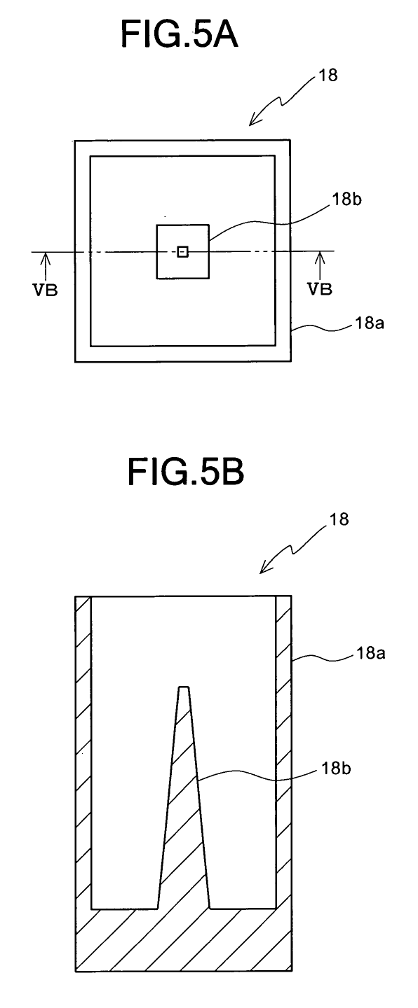

FIGS. 5A and 5B are enlarged views showing the lower fluid handling section 18 of the lower apparatus body 14 of the fluid handling apparatus 10 in this preferred embodiment. FIG. 5A is a plan view of the lower fluid handling section 18, and FIG. 5B is a sectional view taken along line VB-VB of FIG. 5A. As shown in FIGS. 5A and 5B, the lower fluid handling section 18 comprises: an external wall portion 18a which has a substantially square opening in the upper end thereof and which defines therein a recessed portion having a shape of substantially rectangular parallelopiped, each of the length, width and height of the recessed portion being a few millimeters; and a protruding portion 18b which protrudes upwards from the central portion of the bottom face of the recessed portion of the external wall portion 18a, the protruding portion 18b having a shape of substantially rectangular truncated pyramid (a shape formed by cutting the tip portion of a substantially rectangular pyramid in substantially horizontally directions).

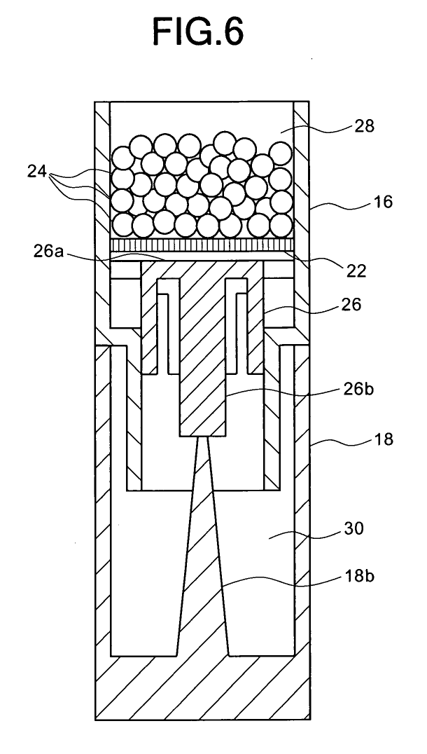

As shown in FIG. 6, if the upper fluid handling section 16 is mounted on the lower fluid handling section 18, the bottom face of the valve rod portion 26b of the valve body 26 of the upper fluid handling section 16 is pushed up by the protruding portion 18b of the lower fluid handling section 18, so that the valve body 26 moves upwards. Then, the bottom face of the valve seat horizontal portion 26a of the valve body 26 leaves the upper face of the horizontal wall portion 20b of the external wall portion 20 of the upper fluid handling section 16 to open the valve, so that a fluid injected into the upper fluid handling chamber 28 is fed into the interior of the lower fluid handling section 18 (a lower fluid handling chamber 30) via the slits 26e of the valve body 26 (see FIGS. 3A and 3B).

Referring to FIGS. 7A through 7E, an example of application of the fluid handling apparatus 10 in this preferred embodiment will be described below. First, as shown in FIG. 7A, a large number of beads 24 coated with an antibody are filled on the mesh member 22 in each of the upper fluid handling sections 16 of the upper apparatus body 12 of the fluid handling apparatus 10 in this preferred embodiment. Then, as shown in FIG. 7B, a reagent is injected into the upper fluid handling chamber 28 serving as a reaction chamber to allow a reaction while the valve body 26 of each of the upper fluid handling sections 16 is closed. Then, if the upper apparatus body 12 is stacked on the lower apparatus body 14, the lower vertical wall portion 20c of the external wall portion 20 of each of the upper fluid handling sections 16 of the upper apparatus body 12 is inserted into a corresponding one of the lower fluid handling sections 18 of the lower apparatus body 14, and the horizontal wall portion 20b of the external wall portion 20 is supported on the corresponding one of the lower fluid handling sections 18, as shown in FIG. 7C. At this time, the bottom face of the valve rod portion 26b of the valve body 26 of each of the upper fluid handling sections 16 is pushed up by the protruding portion 18b of the corresponding one of the lower fluid handling sections 18, so that the valve body 26 moves upwards. Then, the bottom face of the valve seat horizontal portion 26a of the valve body 26 leaves the upper face of the horizontal wall portion 20b of the external wall portion 20 of each of the upper fluid handling sections 16 to open the valve, so that the reacted liquid is discharged from the upper fluid handling chamber 28 into the interior of the corresponding one of the lower fluid handling sections 18 (the lower fluid handling chamber 30) via the slits 26e of the valve body 26. Then, as shown in FIG. 7D, after the upper apparatus body 12 is removed, a reaction stop solution is added into the lower fluid handling chamber 30 of each of the lower fluid handling sections 18 of the lower apparatus body 14 by means of a pipette 32 to stop the reaction, so that it is possible to measure fluorescence in a state shown in FIG. 7E.

### Second Preferred Embodiment

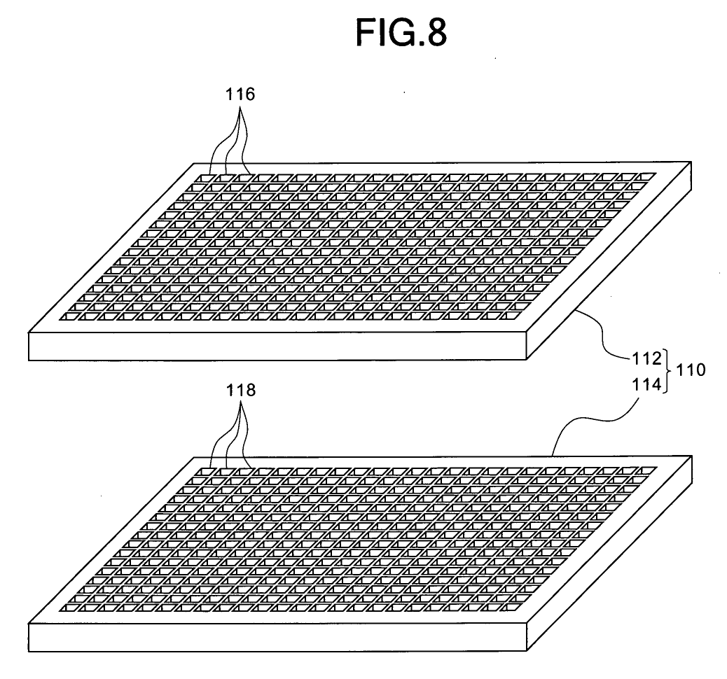

FIGS. 8 through 15E show the second preferred embodiment of a fluid handling apparatus according to the present invention. As shown in FIG. 8, similar to the first preferred embodiment, the fluid handling apparatus 110 in this preferred embodiment comprises an upper apparatus body 112 and a lower apparatus body 114. The fluid handling apparatus 110 is substantially the same as the fluid handling apparatus 10 in the first preferred embodiment, except that the shape of a valve body 126 of each of upper fluid handling sections 116 of the upper apparatus body 112 is different from the shape of the valve body 26 of the fluid handling apparatus 10 in the first preferred embodiment, that the shape of a protruding portion 118b of each of lower fluid handling sections 118 of the lower apparatus body 114 for opening the valve body 126 is different from the shape of the protruding portion 18b of the fluid handling apparatus 10 in the first preferred embodiment, and that cut-out portions 120d are formed in a lower vertical wall portion 120c of an external wall portion 120 of each of the upper fluid handling sections 116.

Similar to the first preferred embodiment, each of the upper apparatus body 112 and the lower apparatus body 114 comprises a substantially rectangular flat plate member which is made of a resin material, such as polycarbonate (PC) or polymethyl methacrylate (PMMA), or a glass material and which has a thickness of a few millimeters, the length of each side of the flat plate member being in the range of from a few centimeters to over ten centimeters. As shown in FIG. 8, the upper apparatus body 112 has a large number of upper fluid handling sections 116 (384(=16×24) upper fluid handling sections in this preferred embodiment), which are arrayed thereon, each of the upper fluid handling sections 116 having a substantially square opening in the upper end thereof. On the other hand, the lower apparatus body 114 has a large number of lower fluid handling sections 118 (384(=16×24) lower fluid handling sections in this preferred embodiment), which are arrayed thereon so that each of the lower fluid handling sections 118 corresponds to a corresponding one of the upper fluid handling sections 116, each of the lower fluid handling sections 18 having a substantially square opening in the upper end thereof.

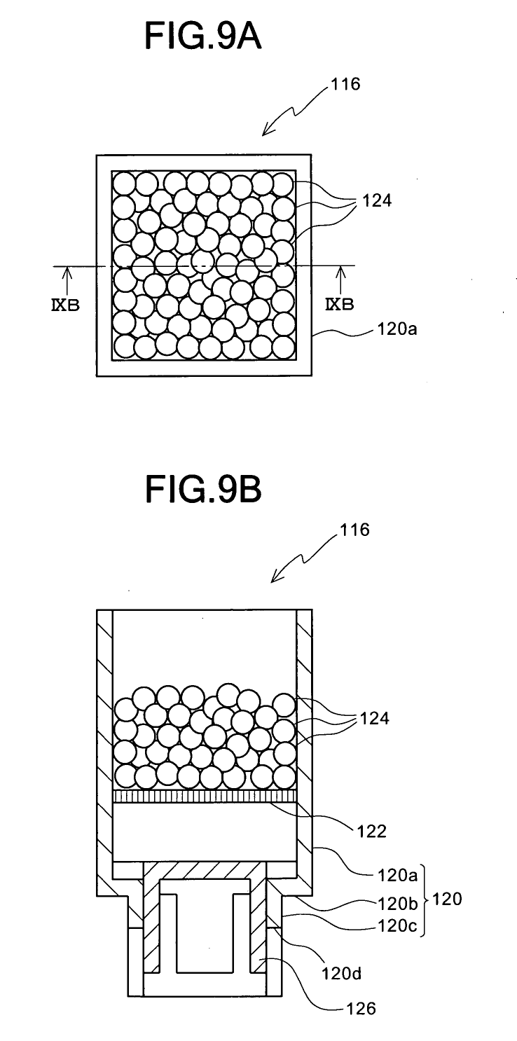

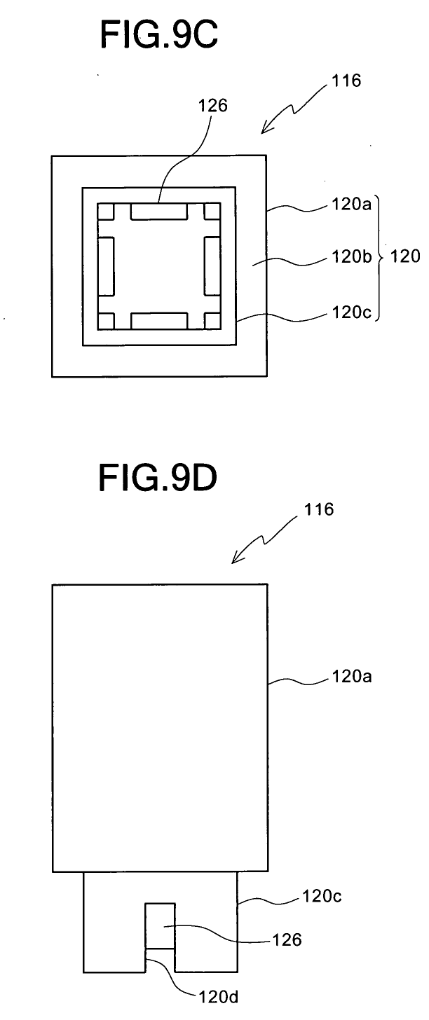

FIGS. 9A through 9D are enlarged views showing one of the upper fluid handling sections 116 of the upper apparatus body 112 of the fluid handling apparatus 110 in this preferred embodiment. FIG. 9A is a plan view of the upper fluid handling section 116, and FIG. 9B is a sectional view taken along line IXB-IXB of FIG. 9A. FIG. 9C is a bottom view of the upper fluid handling section 116, and FIG. 9D is a side view of the upper fluid handling section 116. As shown in FIGS. 9A through 9D, the upper fluid handling section 116 comprises an external wall portion 120, a mesh member 122 mounted in a space defined by the external wall portion 120, a large number of beads 124 filled on the mesh member 122 in the space defined by the external wall portion 120, and a valve body 126 mounted below the mesh member 122 in the space defined by the external wall portion 120.

The external wall portion 120 comprise: an upper vertical wall portion 120a which has a substantially square opening in the upper end thereof and which defines therein a space having a shape of substantially rectangular parallelopiped, each of the length, width and height of the space being a few millimeters; a horizontal wall portion 120b which extends inwardly in horizontal directions from the lower end of the upper vertical wall portion 120a and which extends along the lower end of the upper vertical wall portion 120a to form a substantially square opening which is smaller than the opening formed in the upper end of the upper vertical wall portion 120a; and a lower vertical wall portion 120c which extends downwards in vertical directions from the opening end portion of the opening of the horizontal wall portion 120b to define therein a space having a shape of substantially rectangular parallelopiped and which forms a substantially square opening in the lower end thereof, the opening formed in the lower end of the lower vertical wall portion 120c being smaller than the opening formed in the upper end of the upper vertical wall portion 120a. Furthermore, as shown in FIGS. 9B and 9D, in this preferred embodiment unlike the first preferred embodiment, a cut-out portion 120d extending downwards in vertical directions and passing through the lower vertical wall portion 120c is formed in the substantially central portion of each of a pair of facing surfaces of the lower vertical wall portion 120c.

Similar to the first preferred embodiment, the mesh member 122 is a substantially square mesh member (a member having a mesh structure) which allows fluid to pass therethrough and which inhibit the beads 124 from passing therethrough, the mesh member 122 having a large number of smaller openings than the diameter of each of the beads 124. The mesh member 122 is arranged in the space, which is defined by the upper vertical wall portion 120a, so as to be substantially perpendicular to the upper vertical wall portion 120a, i.e., substantially parallel to the opening formed in the upper end of the upper vertical wall portion 120a. The peripheral portion of the mesh member 122 contacts a lower portion of the inner surface of the upper vertical wall portion 120a than the substantially central portion thereof in vertical directions to be fixed thereto. On the mesh member 122 thus fixed, the large number of beads 124 are filled.

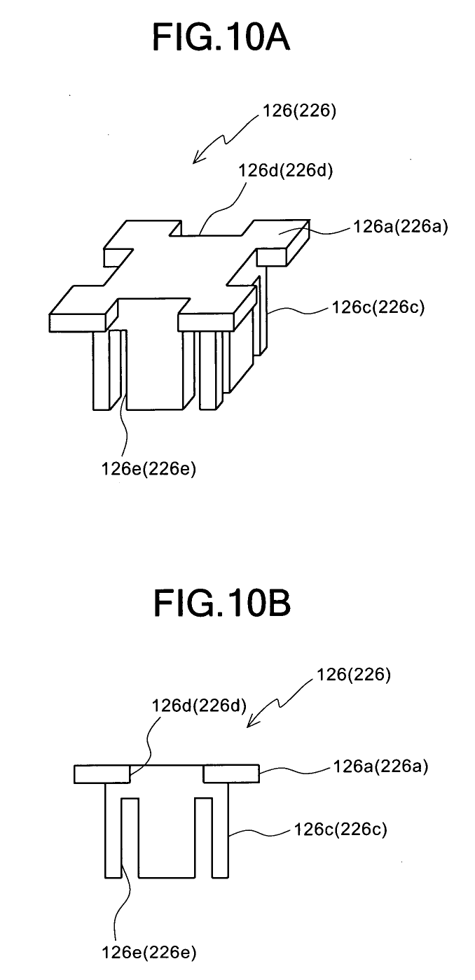

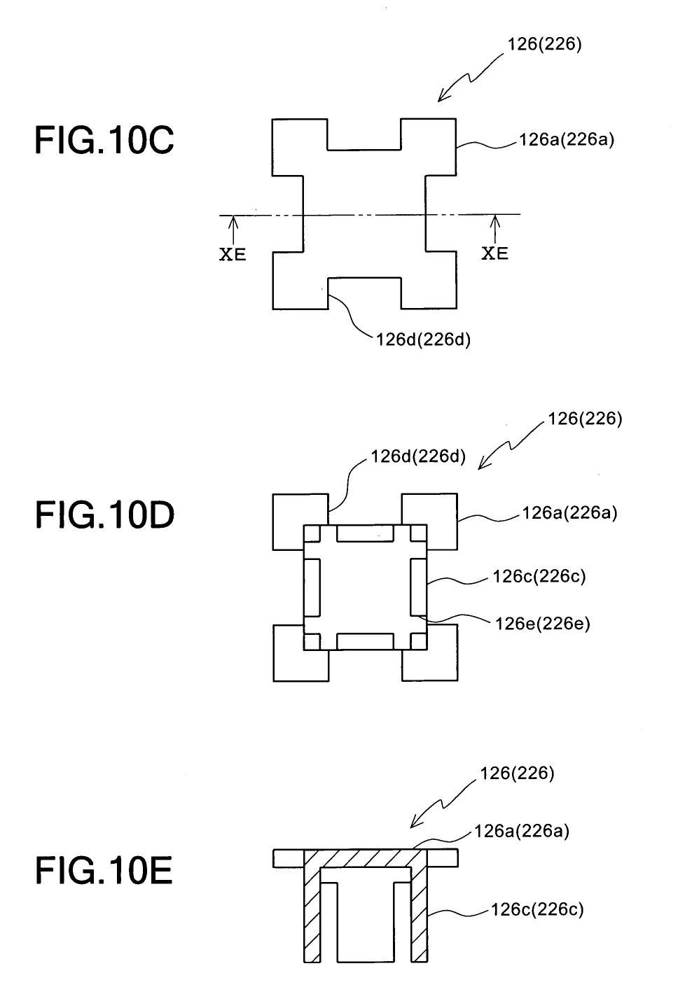

FIGS. 10A through 10E are enlarged views showing a valve body 126 for use in the upper fluid handling section 116 of the upper apparatus body 112 of the fluid handling apparatus 110 in this preferred embodiment. FIG. 10A is a perspective view of the valve body 126, and FIG. 10B is a side view of the valve body 126. FIG. 10C is a plan view of the valve body 126, and FIG. 10D is a bottom view of the valve body 126, FIG. 10E being a sectional view taken along line XE-XE of FIG. 10C. The valve body 126 is integrally formed of a resin material or the like. As shown in FIGS. 10A through 10E, the valve body 126 comprises: a flat-plate-shaped valve seat horizontal portion 126a; and a valve seat vertical portion 126c which extends downward in vertical directions from the bottom face of the valve seat horizontal portion 126a. The valve seat horizontal portion 126a substantially has the same planar shape as the opening formed in the upper end of the upper vertical wall portion 120a of the external wall portion 120, except that each of substantially rectangular cut-out portions 126d is formed in the substantially central portion of a corresponding one of four side faces thereof. The valve seat vertical portion 126c extends along the four side faces of the valve seat horizontal portion 126a, and the outer surface thereof is arranged on the same plane as the bottom face (extending along each of the side faces of the valve seat horizontal portion 126a) of each of the cut-out portions 126d. Each of the four side faces of the valve seat vertical portion 126c has a plurality of slits 126e (two slits in this preferred embodiment) which extend downwards in vertical directions and which pass through the valve seat vertical portion 126c. Furthermore, a plurality of grooves extending downwards in vertical directions without passing through the valve seat vertical portion 126c may be formed in place of the slits 126e.

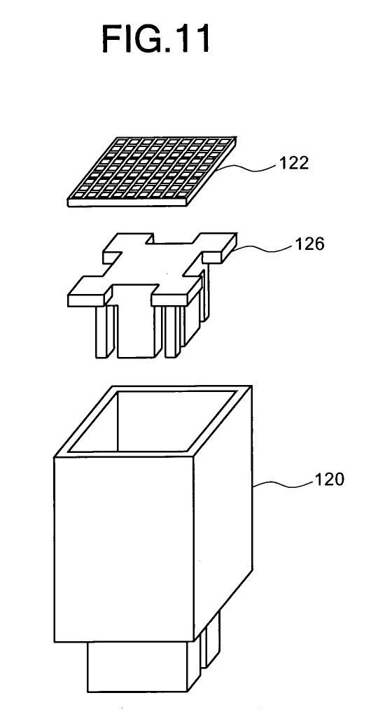

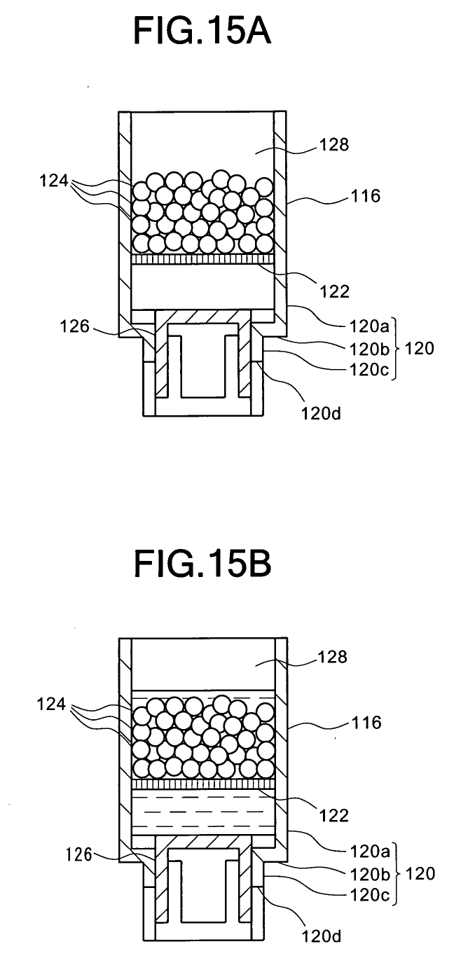

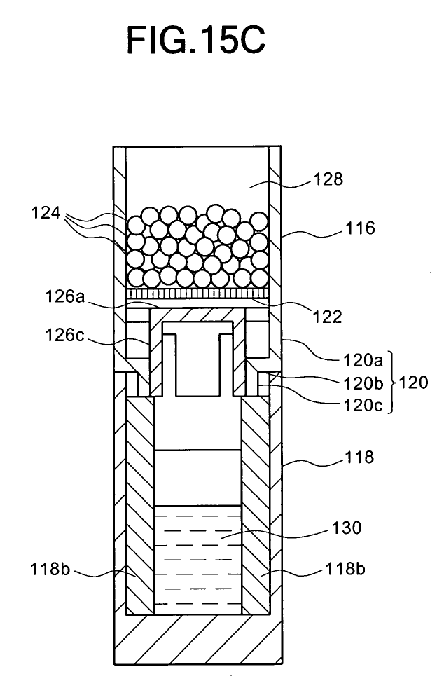

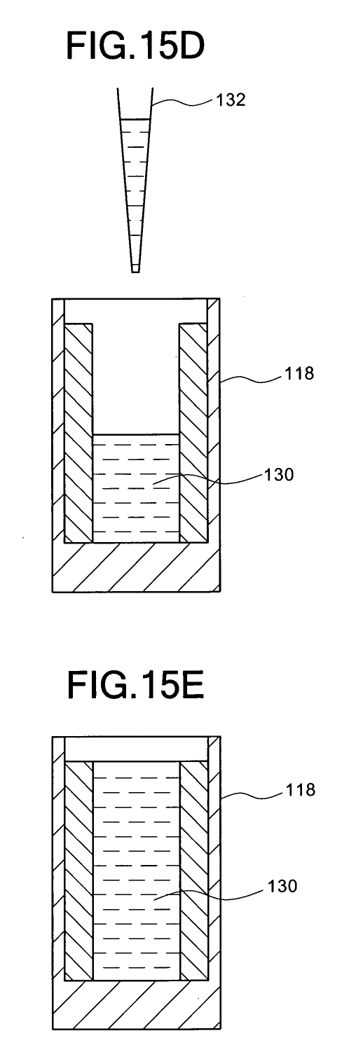

In order to assemble the upper fluid handling section 116 with this construction, as shown in FIG. 11, after the valve body 126 is first inserted into the space defined by the external wall portion 120, the mesh member 122 is inserted into the space defined by the external wall portion 120 to be fixed to the inner surface thereof with an adhesive or the like, and thereafter, the large number of beads 124 are filled on the mesh member 122 in the space defined by the external wall portion 120. The height of the mesh member 122 is set so that the valve body 126 can move upwards to be fully open. If the upper fluid handling section 116 is thus assembled, the opening formed in the upper end of the external wall portion 120 can be used as an inlet for injecting a fluid, such as a liquid sample, and a space serving as an upper fluid handling chamber 128 (see FIG. 15A) is formed above the valve body 126 in the space defined by the external wall portion 120 when the valve body 126 is arranged at the lower end thereof (when the valve is closed). Below the upper fluid handling chamber 128, a communication passage for feeding a fluid into the lower fluid handling section 118 is formed when the valve body 126 moves upwards (when the valve is open).

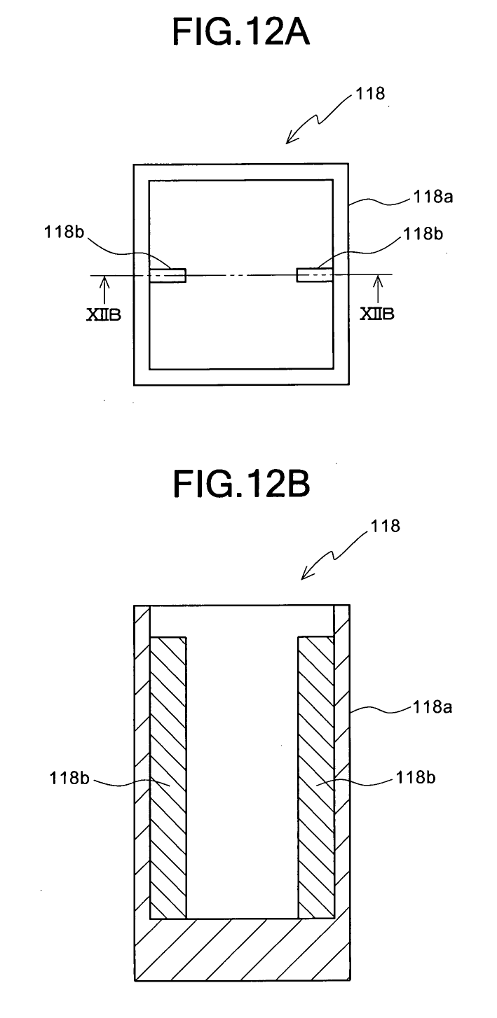

FIGS. 12A and 12B are enlarged views showing the lower fluid handling section 118 of the lower apparatus body 114 of the fluid handling apparatus 110 in this preferred embodiment. FIG. 12A is a plan view of the lower fluid handling section 118, and FIG. 12B is a sectional view taken along line XIIB-XIIB of FIG. 12A. As shown in FIGS. 12A and 12B, the lower fluid handling section 118 comprises: an external wall portion 118a which has a substantially square opening in the upper end thereof and which defines therein a recessed portion having a shape of substantially rectangular parallelopiped, each of the length, width and height of the recessed portion being a few millimeters; and a pair of substantially rectangular flat-plate-shaped protruding portions 118b which extend upwards from the bottom face of the external wall portion 118a along the substantially central portion of the inner face of each of a pair of facing walls of the external wall portion 118a.

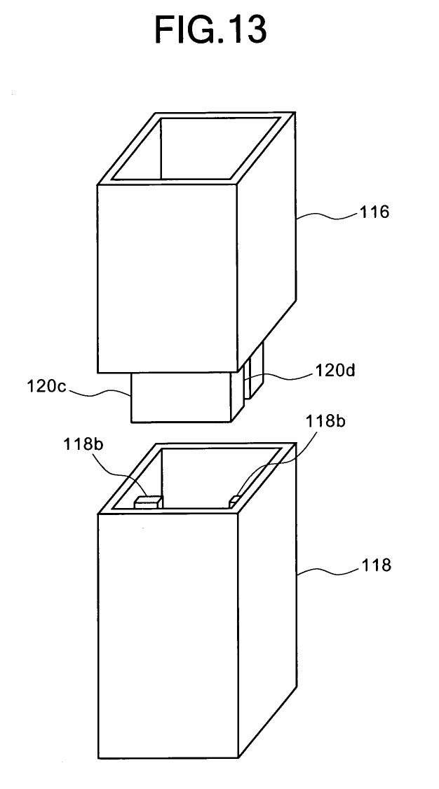

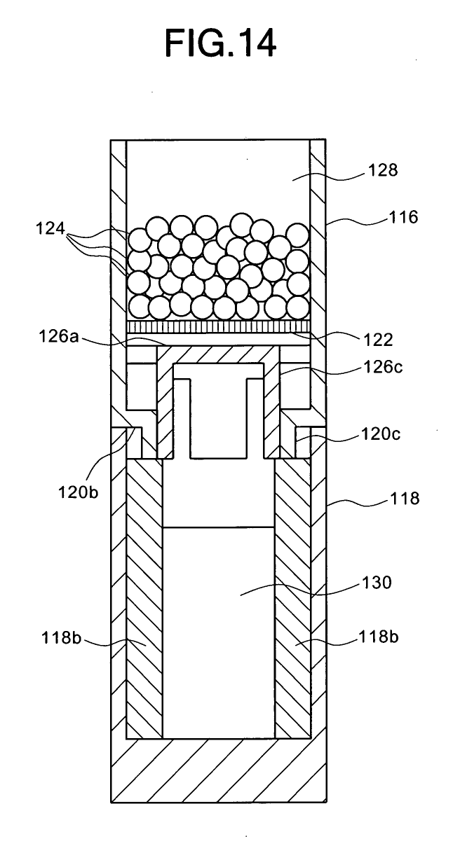

As shown in FIGS. 13 and 14, if the upper fluid handling section 116 is mounted on the lower fluid handling section 118, the bottom face of the valve seat vertical portion 126c of the valve body 126 of the upper fluid handling section 116 is pushed up by the protruding portions 118b of the lower fluid handling section 118, which enter a space defined by the lower vertical wall portion 120c from the cut-out portions 120d of the external wall portion 120 of the upper fluid handling section 116, so that the valve body 126 moves upwards. Then, the bottom face of the valve seat horizontal portion 126a of the valve body 126 leaves the upper face of the horizontal wall portion 120b of the external wall portion 120 of the upper fluid handling section 116 to open the valve, so that a fluid injected into the upper fluid handling chamber 128 is fed into the interior of the lower fluid handling section 118 (a lower fluid handling chamber 130) via the slits 126e of the valve body 126 (see FIGS. 10A and 10B).

Referring to FIGS. 15A through 15E, an example of application of the fluid handling apparatus 110 in this preferred embodiment will be described below. First, as shown in FIG. 15A, a large number of beads 124 coated with an antibody are filled on the mesh member 122 in each of the upper fluid handling sections 116 of the upper apparatus body 112 of the fluid handling apparatus 110 in this preferred embodiment. Then, as shown in FIG. 15B, a reagent is injected into the upper fluid handling chamber 128 serving as a reaction chamber to allow a reaction while the valve body 126 of each of the upper fluid handling sections 116 is closed. Then, if the upper apparatus body 112 is stacked on the lower apparatus body 114, the lower vertical wall portion 120c of the external wall portion 120 of each of the upper fluid handling sections 116 of the upper apparatus body 112 is inserted into a corresponding one of the lower fluid handling sections 118 of the lower apparatus body 114, and the horizontal wall portion 120b of the external wall portion 120 is supported on the corresponding one of the lower fluid handling sections 118, as shown in FIG. 15C. At this time, the bottom face of the valve seat vertical portion 126c of the valve body 126 of each of the upper fluid handling sections 116 is pushed up by the protruding portions 118b of the corresponding one of the lower fluid handling sections 118, which enters the space defined by the lower vertical wall portion 120c of the external wall portion 120 of each of the upper fluid handling sections 116 from the cut-out portions 120d of the external wall portion 120 thereof, so that the valve body 126 moves upwards. Then, the bottom face of the valve seat horizontal portion 126a of the valve body 126 leaves the upper face of the horizontal wall portion 120b of the external wall portion 120 of each of the upper fluid handling sections 116 to open the valve, so that the reacted liquid is discharged from the upper fluid handling chamber 128 into the interior of the corresponding one of the lower fluid handling sections 118 (the lower fluid handling chamber 130) via the slits 126e of the valve body 126. Then, as shown in FIG. 15D, after the upper apparatus body 12 is removed, a reaction stop solution is added into the lower fluid handling chamber 130 of each of the lower fluid handling sections 118 of the lower apparatus body 114 by means of a pipette 132 to stop the reaction, so that it is possible to measure fluorescence in a state shown in FIG. 15E.

### Third Preferred Embodiment

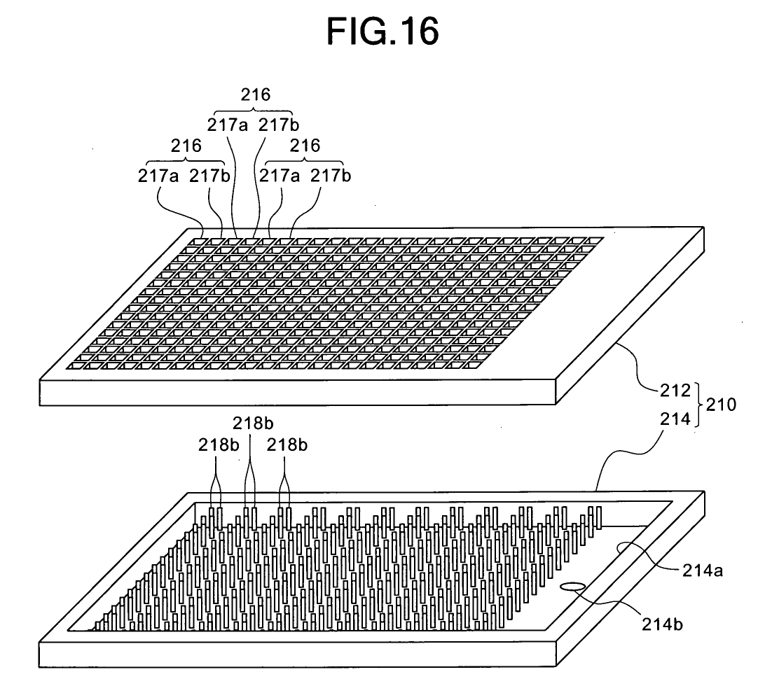

FIGS. 16 through 22F show the third preferred embodiment of a fluid handling apparatus according to the present invention. As shown in FIG. 16, similar to the first and second preferred embodiments, the fluid handling apparatus 210 in this preferred embodiment comprises an upper apparatus body 212 and a lower apparatus body 214. The fluid handling apparatus 210 is substantially the same as the fluid handling apparatus 110 in the second preferred embodiment, except that each of upper fluid handling sections 216 comprises a first upper fluid handling division (divisional section or subsection) 217a and a second fluid handling division (divisional section or subsection) 217b, the first and second upper fluid handling divisions 217a and 217b being communicated with each other via slits 223, and that a lower apparatus body 214 is capable of being used as an exclusive tray for drain by forming an outlet 214b in the bottom of a recessed portion 214a thereof, without forming the external wall portions 118a for defining each of the lower fluid handling sections 118 in the second preferred embodiment.

Similar to the first and second preferred embodiments, each of the upper apparatus body 212 and the lower apparatus body 214 comprises a substantially rectangular flat plate member which is made of a resin material, such as polycarbonate (PC) or polymethyl methacrylate (PMMA), or a glass material and which has a thickness of a few millimeters, the length of each side of the flat plate member being in the range of from a few centimeters to over ten centimeters. As shown in FIG. 16, the upper apparatus body 212 has a large number of substantially square openings (384 (=16×24) openings in this preferred embodiment) in the upper face thereof. The first and second upper fluid handling divisions 217a and 217b are formed in adjacent two of the openings, respectively, so that a large number of upper fluid handling sections 216 (192 (=16×12) upper fluid handling sections in this preferred embodiment) are arrayed. On the other hand, the upper face of the lower apparatus body 214 has a substantially rectangular recessed portion 214a, the bottom face of which has an outlet 214b. The lower apparatus body 214 has a large number of pairs of protruding portions 218b which protrude upwards in vertical directions from the bottom face of the recessed portion 214a. Each pair of the protruding portions 218b are used for pushing up and opening each of valve bodies 226 which will be described later.

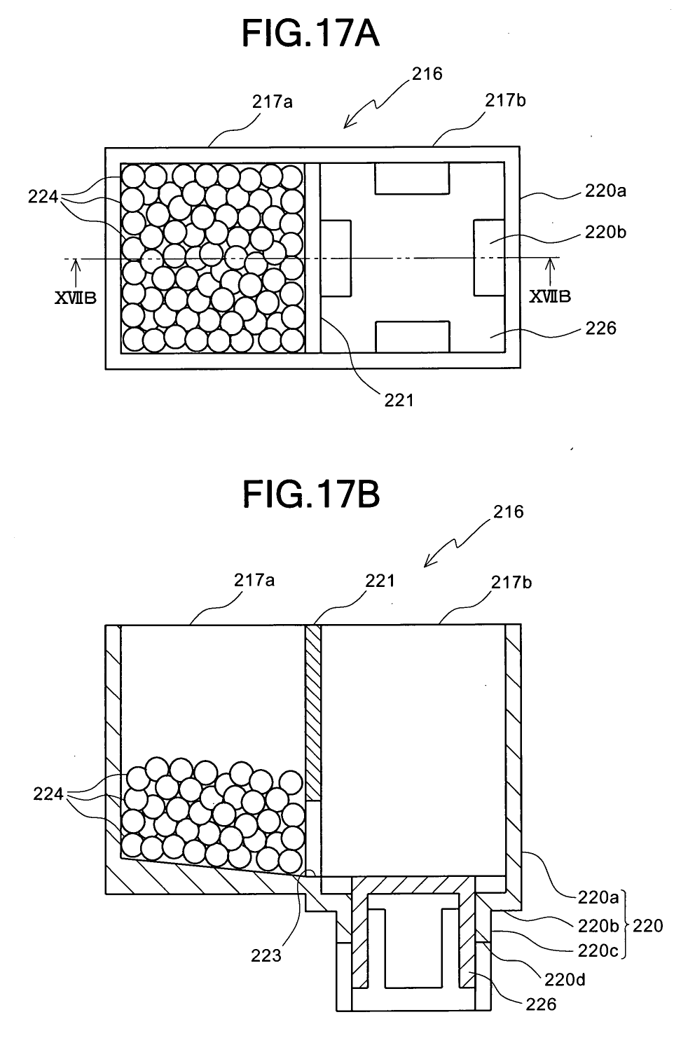

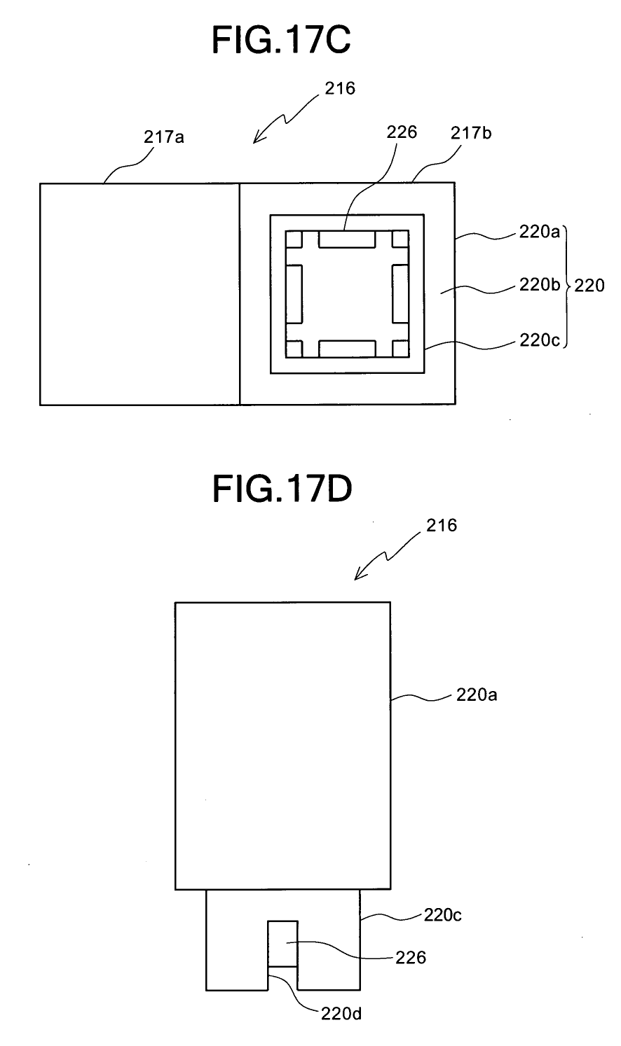

FIGS. 17A through 17D are enlarged views showing one of the upper fluid handling sections 216 of the upper apparatus body 212 of the fluid handling apparatus 210 in this preferred embodiment. FIG. 17A is a plan view of the upper fluid handling section 216, and FIG. 17B is a sectional view taken along line XVIIB-XVIIB of FIG. 17A. FIG. 17C is a bottom view of the upper fluid handling section 216, and FIG. 17D is a side view of the upper fluid handling section 216. As shown in FIGS. 17A through 17D, the upper fluid handling section 216 comprises a first upper fluid handling division 217a and a second upper fluid handling division 217b. Each of the first and second upper fluid handling divisions 217a and 217b has a substantially square opening in the upper end thereof to form therein a space having a shape of substantially rectangular parallelopiped, each of the length, width and height of the space being a few millimeters. The first and second upper fluid handling divisions 217a and 217b are surrounded by an external wall portion 220, and are separated from each other by means of a partition plate 221. The first upper fluid handling division 217a has a large number of beads 224 filled therein, and the second upper fluid handling division 217b has a valve body 226 mounted on the bottom portion thereof. The first and second upper fluid handling divisions 217a and 217b are communicated with each other via one or a plurality of slits 223 which pass through the partition plate 221 and extend in vertical directions and which have a smaller width than the diameter of each of the beads 224.

The external wall portion 220 comprise: an upper vertical wall portion 220a which defines therein a space having a shape of substantially rectangular parallelopiped for each of the first and second upper fluid handling divisions 217a and 217b; a horizontal wall portion 220b which forms the bottom portion of the first upper fluid handling division 217a and which extends inwardly in horizontal directions from the lower end of the upper vertical wall portion 220a on the side of the second upper fluid handling division 217b and extends along the lower end of the upper vertical wall portion 220a to form a substantially square opening which is smaller than the opening formed in the upper end of the second upper fluid handling division 217b; and a lower vertical wall portion 220c which extends downwards in vertical directions from the opening end portion of the opening of the horizontal wall portion 220b to define there in a space having a shape of substantially rectangular parallelopiped and which forms a substantially square opening in the lower end thereof, the opening formed in the lower end of the lower vertical wall portion 220c being smaller than the opening formed in the upper end of the second upper fluid handling section 217b. Furthermore, as shown in FIGS. 17B and 17D, in this preferred embodiment similar to the second preferred embodiment, a cut-out portion 220d extending downwards in vertical directions and passing through the lower vertical wall portion 220c is formed in the substantially central portion of each of a pair of facing surfaces of the lower vertical wall portion 220c.

The valve body 226 for use in the upper fluid handling section 216 of the upper apparatus body 212 of the fluid handling apparatus 210 in this preferred embodiment is the same as the valve body 126 in the second preferred embodiment shown in FIGS. 10A through 10E. That is, the valve body 226 is integrally formed of a transparent resin material or the like, and comprises: a flat-plate-shaped valve seat horizontal portion 226a; and a valve seat vertical portion 226c which extends downward in vertical directions from the bottom face of the valve seat horizontal portion 226a, as shown in FIGS. 10A through 10E. The valve seat horizontal portion 226a substantially has the same planar shape as the opening formed in the upper end of the upper vertical wall portion 220a of the external wall portion 220, except that each of substantially rectangular cut-out portions 226d is formed in the substantially central portion of a corresponding one of four side faces thereof. The valve seat vertical portion 226c extends along the four side faces of the valve seat horizontal portion 226a, and the outer surface thereof is arranged on the same plane as the bottom face (extending along each of the side faces of the valve seat horizontal portion 226a) of each of the cut-out portions 226d. Each of the four side faces of the valve seat vertical portion 226c has a plurality of slits 226e (two slits in this preferred embodiment) which extend downwards in vertical directions and which pass through the valve seat vertical portion 226c.

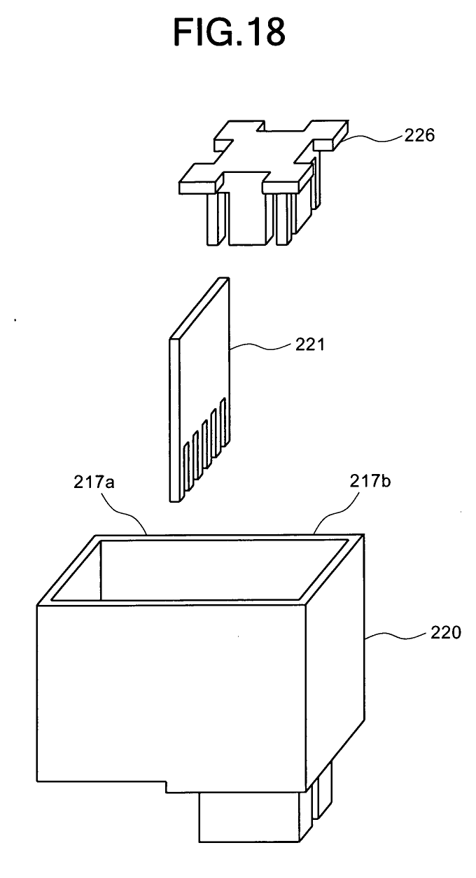

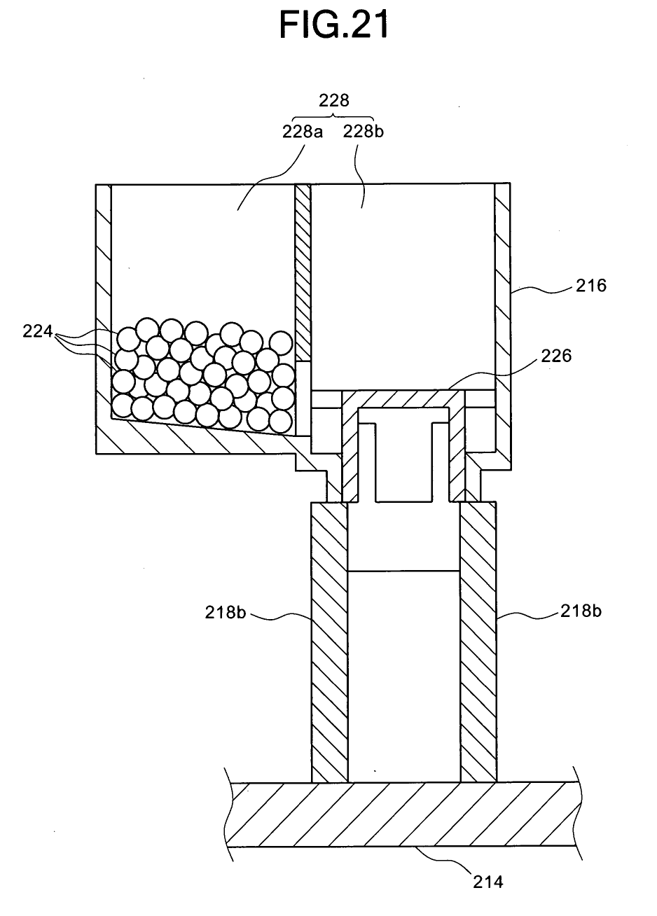

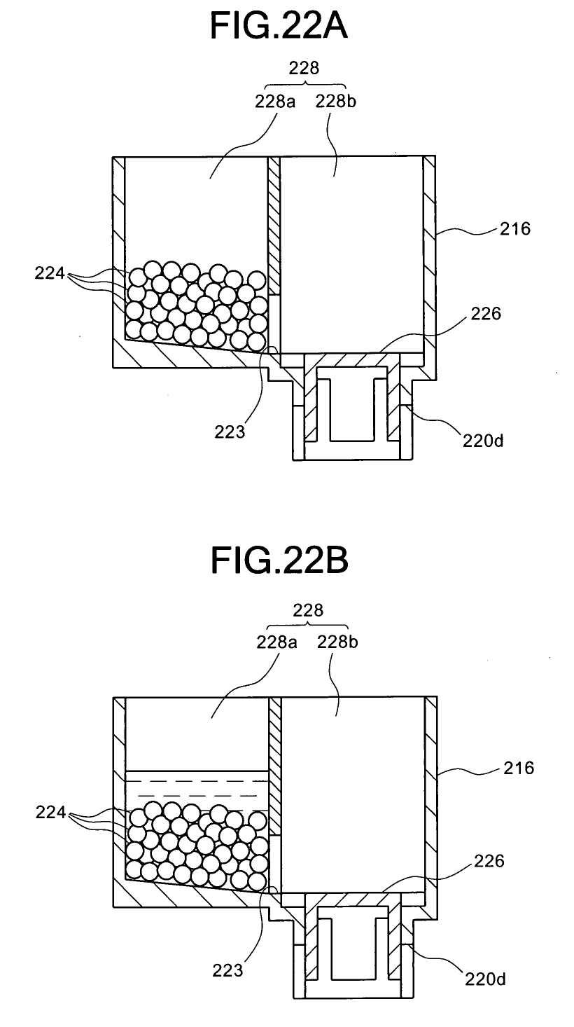

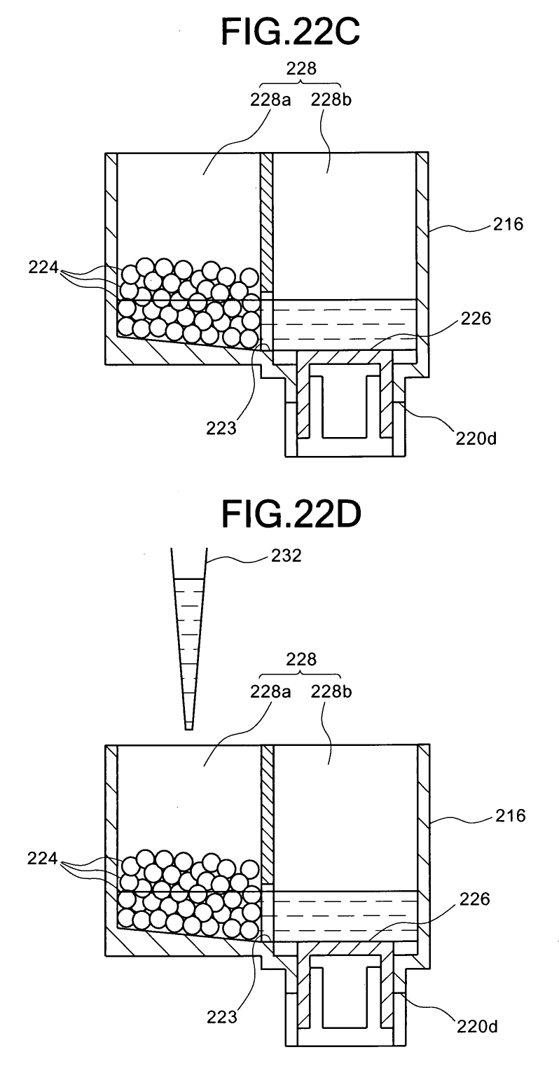

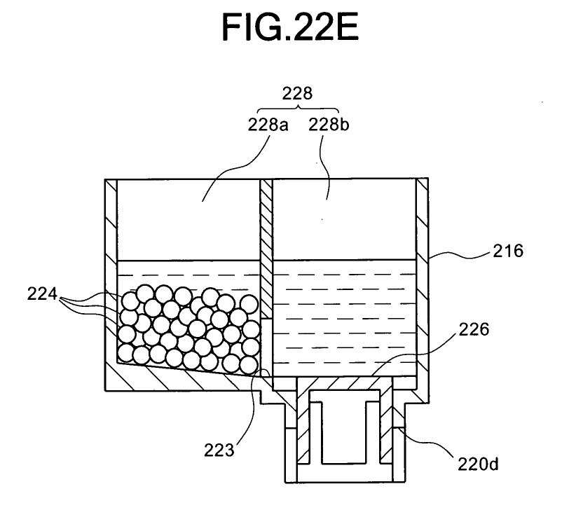

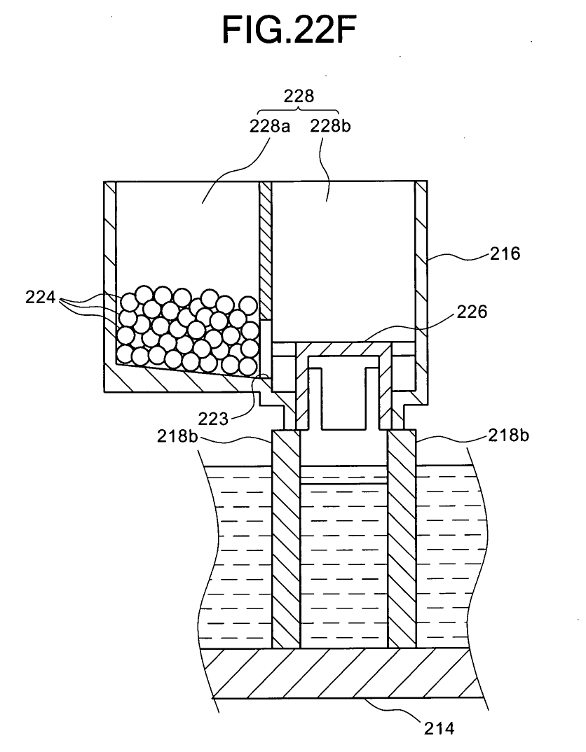

In order to assemble the upper fluid handling section 216 with this construction, as shown in FIG. 18, after the partition plate 221 is arranged between the first and second upper fluid handling divisions 217a and 217b to be fixed to the external wall portion 220, the valve body 226 is inserted into the second upper fluid handling division 217b, and the large number of beads 224 are filled in the first upper fluid handling division 217a. If the upper fluid handling section 216 is thus assembled, the opening formed in the upper end of the first upper fluid handling division 217a can be used as an inlet for injecting a fluid, such as a liquid sample. In addition, a first upper fluid handling chamber 228a (see FIG. 21), which is one of divisional parts of an upper fluid handling chamber 228, is formed in the first upper fluid handling division 217a, and a space serving as a second upper fluid handling chamber 228b (see FIG. 22A), which is the other divisional part of the upper fluid handling chamber 228, is formed above the valve body 226 in the space defined by the external wall portion 220 when the valve body 226 is arranged at the lower end thereof (when the valve is closed). Below the second upper fluid handling chamber 228b, a communication passage for feeding a fluid into the recessed portion 214b of the lower apparatus body 214 is formed when the valve body 226 moves upwards (when the valve is open).

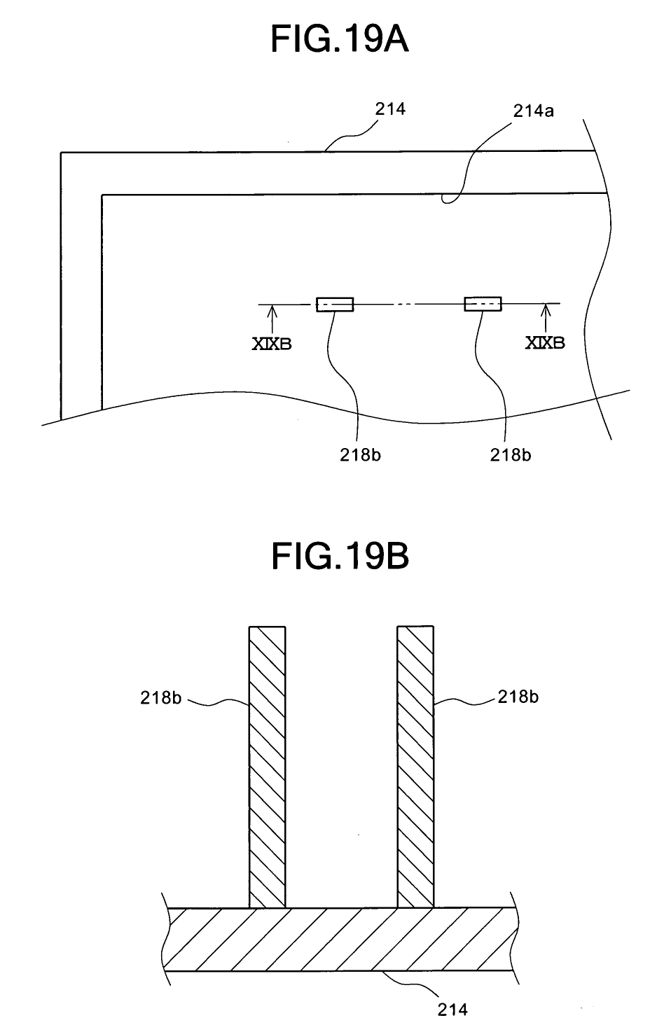

FIGS. 19A and 19B are enlarged views showing a part of the lower apparatus body 214 of the fluid handling apparatus 210 in this preferred embodiment. FIG. 19A is a plan view of a part of the lower apparatus body 214, and FIG. 19B is a sectional view taken along line XIXB-XIXB of FIG. 19A. As shown in FIGS. 19A and 19B, in this preferred embodiment, a pair of protruding portions 218b extending upwards in vertical directions from the bottom face of the recessed portion 214a of the lower apparatus body 214 are arranged at an interval so as to correspond to the cut-out portions 220d of each of the upper fluid handling sections 216, without forming the external wall portions 118a for defining each of the lower fluid handling sections 118 in the second preferred embodiment.

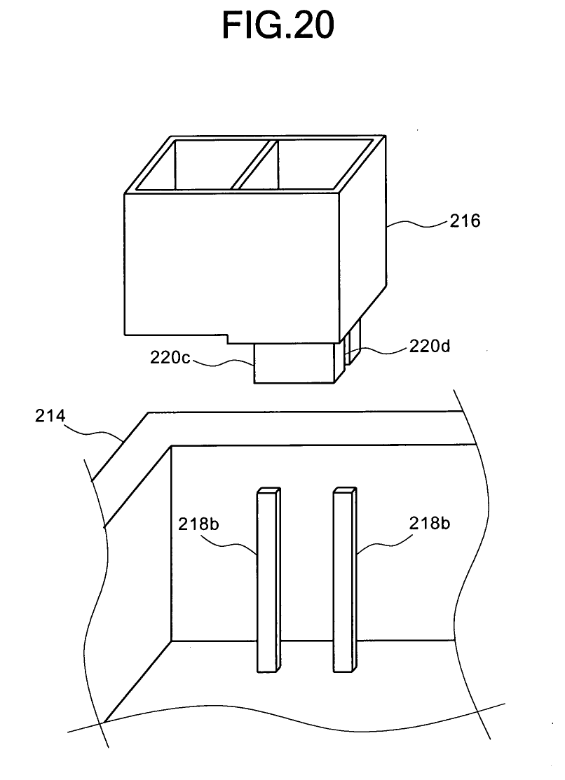

As shown in FIGS. 20 and 21, if the upper apparatus body 212 is mounted on the lower apparatus body 214, the bottom face of the valve seat vertical portion 226c of the valve body 226 of the upper fluid handling section 216 is pushed up by the protruding portions 218b of the lower apparatus body 214, which enter a space defined by the lower vertical wall portion 220c from the cut-out portions 220d of the external wall portion 220 of the upper fluid handling section 216, so that the valve body 226 moves upwards. Then, the bottom face of the valve seat horizontal portion 226a of the valve body 226 leaves the upper face of the horizontal wall portion 220b of the external wall portion 220 of the upper fluid handling section 216 to open the valve, so that a fluid injected into the upper fluid handling chamber 228 is fed into the recessed portion 214a of the lower apparatus body 214 via the slits 226e of the valve body 226 (see FIGS. 10A and 10B).

Referring to FIGS. 22A through 22F, the first example of application of the fluid handling apparatus 210 in this preferred embodiment will be described below.

First, as shown in FIG. 22A, a large number of beads 224 coated with an antibody are filled in the first upper fluid handling chamber 228a of each of the upper fluid handling sections 216 of the upper apparatus body 212 of the fluid handling apparatus 210 in this preferred embodiment. Then, as shown in FIG. 22B, a reagent is injected into the first upper fluid handling chamber 228a serving as a reaction chamber to allow a reaction while the valve body 226 of each of the upper fluid handling sections 216 is closed. At this time, as shown in FIG. 22C, the injected reagent is also fed into the second upper fluid handling chamber 228b via the slits 223. Then, as shown in FIG. 22D, a reaction stop solution is added into the first upper fluid handling chamber 228a of each of the upper fluid handling sections 216 of the upper apparatus body 212 by means of a pipette 232 to stop the reaction, so that it is possible to measure fluorescence in a state shown in FIG. 22E. Thereafter, if the upper apparatus body 212 is stacked on the lower apparatus body 214, as shown in FIG. 22F, the bottom face of the valve seat vertical portion 226c of the valve body 226 of each of the upper fluid handling sections 216 is pushed up by the protruding portions 218b of the lower apparatus body 214, which enter the space defined by the lower vertical wall portion 220c of the external wall portion 220 of each of the upper fluid handling sections 216 from the cut-out portions 220d of the external wall portion 220 thereof, so that the valve body 226 moves upwards. Then, the bottom face of the valve seat horizontal portion 226a of the valve body 226 leaves the upper face of the horizontal wall portion 220b of the external wall portion 220 of each of the upper fluid handling sections 216 to open the valve, so that the reacted liquid is fed from the upper fluid handling chamber 228 into the recessed portion 214a of the lower apparatus body 214 via the slits 226e of the valve body 226 to be discharged from the outlet 214b.

Referring to FIGS. 22A through 22F, the second example of application of the fluid handling apparatus 210 in this preferred embodiment will be described below.

First, as shown in FIG. 22A, a large number of beads 224 coated with an antibody are filled in the first upper fluid handling chamber 228a of each of the upper fluid handling sections 216 of the upper apparatus body 212 of the fluid handling apparatus 210 in this preferred embodiment. Then, as shown in FIG. 22B, an antigen is injected into the first upper fluid handling chamber 228a serving as a reaction chamber to allow the antigen to react with the antibody coated on the beads 224 while the valve body 226 of each of the upper fluid handling sections 216 is closed. At this time, as shown in FIG. 22C, the injected antigen is also fed into the second upper fluid handling chamber 228b via the slits 223. Then, if the upper apparatus body 212 is stacked on the lower apparatus body 214, the bottom face of the valve seat vertical portion 226c of the valve body 226 of each of the upper fluid handling sections 216 is pushed up by the protruding portions 218b of the lower apparatus body 214, which enter the space defined by the lower vertical wall portion 220c of the external wall portion 220 of each of the upper fluid handling sections 216 from the cut-out portions 220d of the external wall portion 220 thereof, so that the valve body 226 moves upwards, as shown in FIG. 22F. Then, the bottom face of the valve seat horizontal portion 226a of the valve body 226 leaves the upper face of the horizontal wall portion 220b of the external wall portion 220 of each of the upper fluid handling sections 216 to open the valve, so that the reacted liquid is fed from the upper fluid handling chamber 228 into the recessed portion 214a of the lower apparatus body 214 via the slits 226e of the valve body 226 to be discharged from the outlet 214b. After the reacted liquid is discharged, a washing solution is injected into the first upper fluid handling chamber 228a to wash the interior thereof while the valve body 226 of each of the upper fluid handling sections 216 is open.

Then, as shown in FIG. 22B, the upper apparatus body 212 is removed from the lower apparatus body 214, and a biotin labeled antibody is injected into the first upper fluid handling chamber 228a to allow a reaction while the valve body 226 of each of the upper fluid handling sections 216 is closed. At this time, as shown in FIG. 22C, the injected biotin labeled antibody is also fed into the second upper fluid handling chamber 228b via the slits 223. Then, as shown in FIG. 22F, the upper apparatus body 212 is stacked on the lower apparatus body 214 to open the valve, so that the reacted liquid is fed from the upper fluid handling chamber 228 into the recessed portion 214a of the lower apparatus body 214 via the slits 226e of the valve body 226 to be discharged from the outlet 214b. After the reacted liquid is discharged, a washing solution is injected into the first upper fluid handling chamber 228a to wash the interior thereof while the valve body 226 of each of the upper fluid handling sections 216 is open.

Then, as shown in FIG. 22B, the upper apparatus body 212 is removed from the lower apparatus body 214, and a streptoavidin-enzyme is injected into the first upper fluid handling chamber 228a to allow a reaction while the valve body 226 of each of the upper fluid handling sections 216 is closed. At this time, as shown in FIG. 22C, the injected streptoavidin-enzyme is also fed into the second upper fluid handling chamber 228b via the slits 223. Then, as shown in FIG. 22F, the upper apparatus body 212 is stacked on the lower apparatus body 214 to open the valve, so that the reacted liquid is fed from the upper fluid handling chamber 228 into the recessed portion 214a of the lower apparatus body 214 via the slits 226e of the valve body 226 to be discharged from the outlet 214b. After the reacted liquid is discharged, a washing solution is injected into the first upper fluid handling chamber 228a to wash the interior thereof while the valve body 226 of each of the upper fluid handling sections 216 is open.

Then, as shown in FIG. 22B, the upper apparatus body 212 is removed from the lower apparatus body 214, and a substrate is injected into the first upper fluid handling chamber 228a to allow a reaction while the valve body 226 of each of the upper fluid handling sections 216 is closed. As shown in FIG. 22C, the reacted solution thus emitting fluorescence is also fed into the second upper fluid handling chamber 228b via the slits 223. Then, as shown in FIG. 22D, a reaction stop solution is added into the first upper fluid handling chamber 228a of each of the upper fluid handling sections 216 of the upper apparatus body 212 by means of a pipette 232 to stop the reaction, so that it is possible to measure fluorescence in a state shown in FIG. 22E.

### Fourth Preferred Embodiment

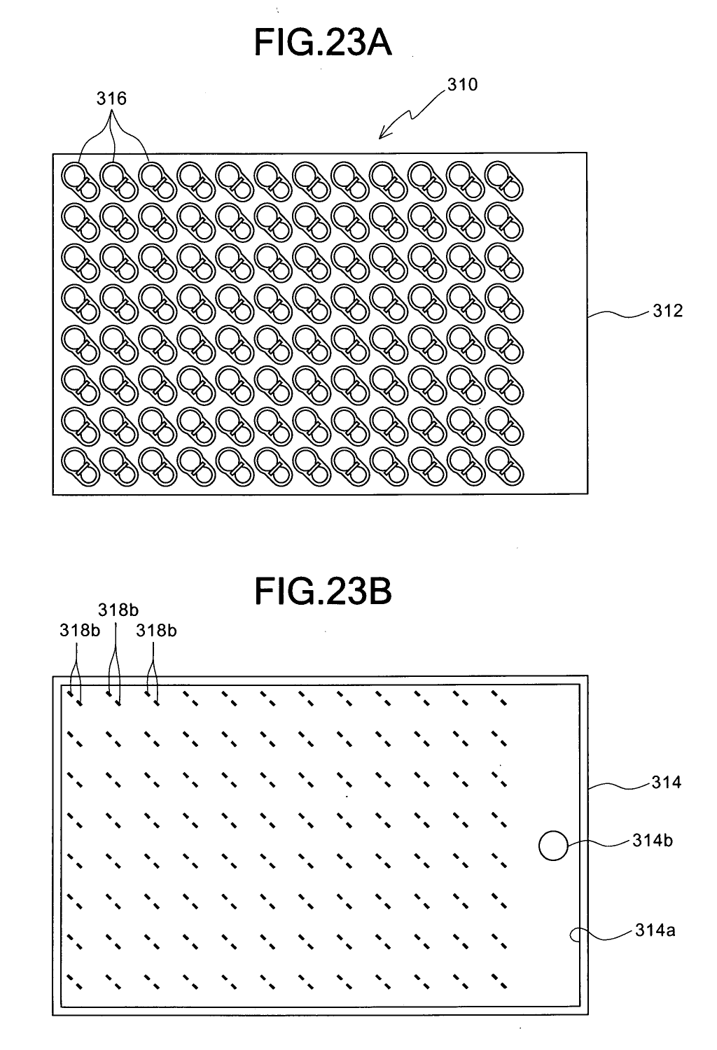

FIGS. 23A through 29 show the fourth preferred embodiment of a fluid handling apparatus according to the present invention. As shown in FIGS. 23A and 23B, similar to the third preferred embodiment, the fluid handling apparatus 310 in this preferred embodiment comprises an upper apparatus body 312 and a lower apparatus body 314. In the fluid handling apparatus 310, the lower apparatus body 314 can be used as an exclusive tray for drain similar to the third preferred embodiment. However, each of upper fluid handling sections 316 of the upper apparatus body 312 of the fluid handling apparatus 310 is different from each of the upper fluid handling sections 216 of the upper apparatus body 212 of the fluid handling apparatus 210 in the third preferred embodiment.

Similar to the third preferred embodiment, each of the upper apparatus body 312 and the lower apparatus body 314 comprises a substantially rectangular flat plate member which is made of a resin material, such as polycarbonate (PC) or polymethyl methacrylate (PMMA), or a glass material and which has a thickness of a few millimeters, the length of each side of the flat plate member being in the range of from a few centimeters to over ten centimeters. As shown in FIG. 23A, the upper apparatus body 312 has a large number of substantially guitar-shaped openings (96(=8×12) openings in this preferred embodiment) in the upper face thereof, and an upper fluid handling subassembly for forming an upper fluid handling section 316 is inserted into each of the openings, so that a large number of upper fluid handling sections 316 are arrayed on the upper apparatus body 312. On the other hand, the upper face of the lower apparatus body 314 has a substantially rectangular recessed portion 314a, the bottom face of which has an outlet 314b. The lower apparatus body 314 has a large number of pairs of protruding portions 318b which protrude upwards in vertical directions from the bottom face of the recessed portion 314a. Each pair of the protruding portions 318b are used for pushing up and opening each of valve bodies 326 which will be described later.

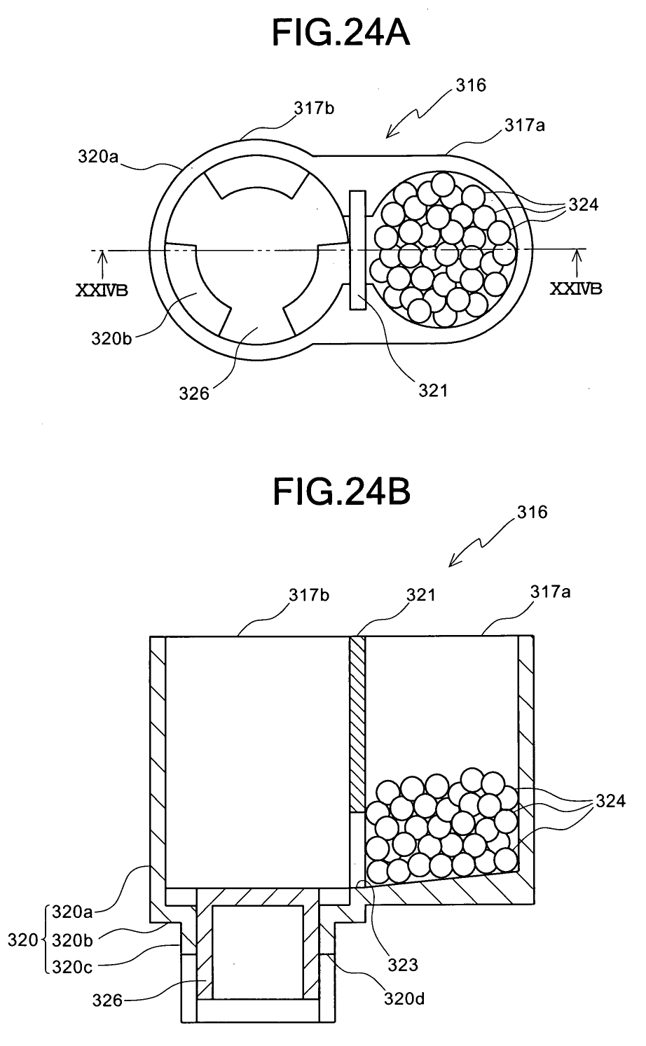

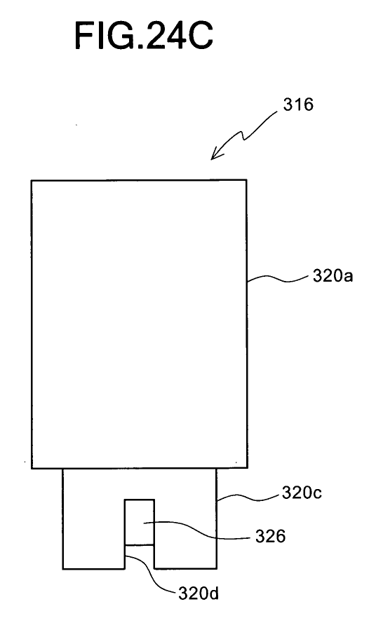

FIGS. 24A through 24C are enlarged views showing one of the upper fluid handling sections 316 of the upper apparatus body 312 of the fluid handling apparatus 310 in this preferred embodiment. FIG. 24A is a plan view of the upper fluid handling section 316, and FIG. 24B is a sectional view taken along line XXIVB-XXIVB of FIG. 24A, FIG. 24C being a side view of the upper fluid handling section 316. As shown in FIGS. 24A through 24C, the upper fluid handling section 316 has a substantially guitar-shaped planar shape, and comprises a substantially cylindrical first upper fluid handling division 317a and a substantially cylindrical second upper fluid handling division 317b. Each of the first and second upper fluid handling divisions 317a and 317b has a substantially circular opening in the upper end thereof to form therein a substantially cylindrical space, each of the diameter and height of the space being a few millimeters. The first and second upper fluid handling divisions 317a and 317b are surrounded by an external wall portion 320, and are separated from each other by a partition plate 321. The first upper fluid handling division 317a has a large number of beads 324 filled therein, and the second upper fluid handling division 317b has a valve body 326 mounted on the bottom portion thereof. The first and second upper fluid handling divisions 317a and 317b are communicated with each other via one or a plurality of slits 323 which pass through the partition plate 321 and extend in vertical directions and which have a smaller width than the diameter of each of the beads 324.

The external wall portion 320 comprise: an upper vertical wall portion 320a which defines therein a substantially cylindrical space for each of the first and second upper fluid handling divisions 317a and 317b by the partition plate 321; a horizontal wall portion 320b which forms the bottom portion of the first upper fluid handling division 317a and which extends inwardly in horizontal directions from the lower end of the upper vertical wall portion 320a on the side of the second upper fluid handling division 317b and extends along the lower end of the upper vertical wall portion 320a to form a substantially circular opening which is smaller than the opening formed in the upper end of the second upper fluid handling division 317b; and a lower vertical wall portion 320c which extends downwards in vertical directions from the opening end portion of the opening of the horizontal wall portion 320b to define therein a substantially cylindrical space and which forms a substantially circular opening in the lower end thereof, the opening formed in the lower end of the lower vertical wall portion 320c being smaller than the opening formed in the upper end of the second upper fluid handling section 317b. Furthermore, as shown in FIGS. 24B and 24C, in this preferred embodiment similar to the third preferred embodiment, a pair of cut-out portions 320d extending downwards in vertical directions and passing through the lower vertical wall portion 320c are formed in facing portions in radial directions of the lower vertical wall portion 320c.

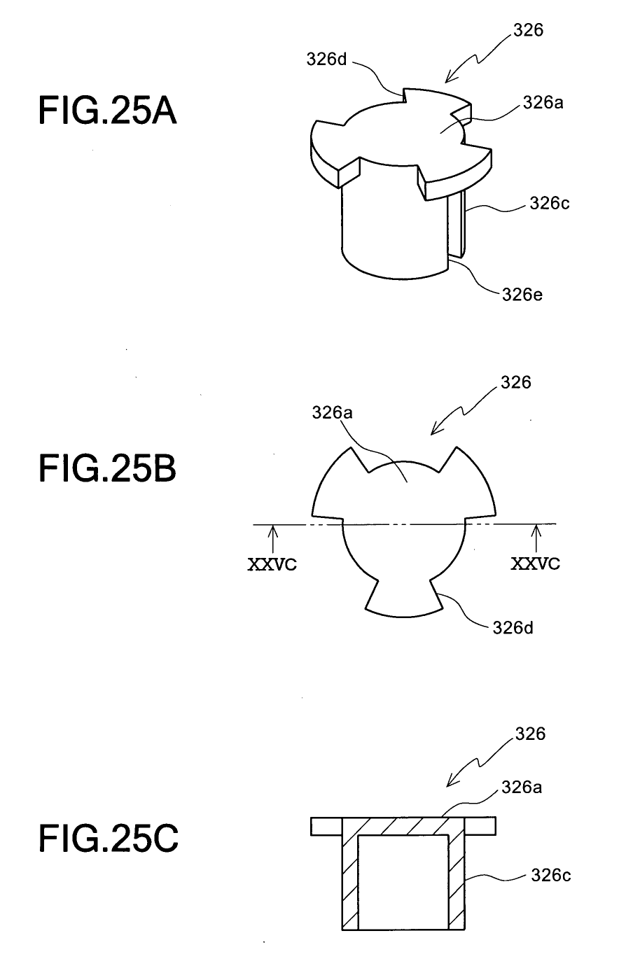

FIGS. 25A through 25C are enlarged views showing a valve body 326 for use in the upper fluid handling section 316 of the upper apparatus body 312 of the fluid handling apparatus 310 in this preferred embodiment. FIG. 25A is a perspective view of the valve body 326, and FIG. 25B is a plan view of the valve body 126, FIG. 25C being a sectional view taken along line XXVC-XXVC of FIG. 25B. In the valve body 326 in this preferred embodiment, the planar shape of a valve seat horizontal portion 326a is substantially circular. At this point, the valve body 326 is different from the valve body 126 (226) in the second and third preferred embodiments wherein the planar shape of the valve seat horizontal portion 126a (226a) is substantially square as shown in FIGS. 10A through 10E. That is, the valve body 326 is integrally formed of a transparent resin material or the like. As shown in FIGS. 25A through 25C, the valve body 326 comprises: a substantially disk-shaped valve seat horizontal portion 326a; and a valve seat vertical portion 326c which extends downward in vertical directions from the bottom face of the valve seat horizontal portion 326a. The valve seat horizontal portion 326a has a planar shape formed by cutting a plurality of substantially sector cut-out portions 326d (three sector cut-out portions in this preferred embodiment) away from the peripheral portion of a disk which has the same planar shape as the opening formed in the upper end of the upper vertical wall portion 320a. The valve seat vertical portion 326c extends along the periphery of the valve seat horizontal portion 326a, and the outer surface thereof is arranged on the same plane as the bottom face (extending along the side face of the valve seat horizontal portion 326a) of each of the cut-out portions 326d. In the valve seat vertical portion 326c, a plurality of slits 326e (three slits in this preferred embodiment) passing through the valve seat vertical portion 326c and extending downwards in vertical directions are formed at intervals. Furthermore, a plurality of grooves extending downwards in vertical directions without passing through the valve seat vertical portion 326c may be formed in place of the slits 326e.

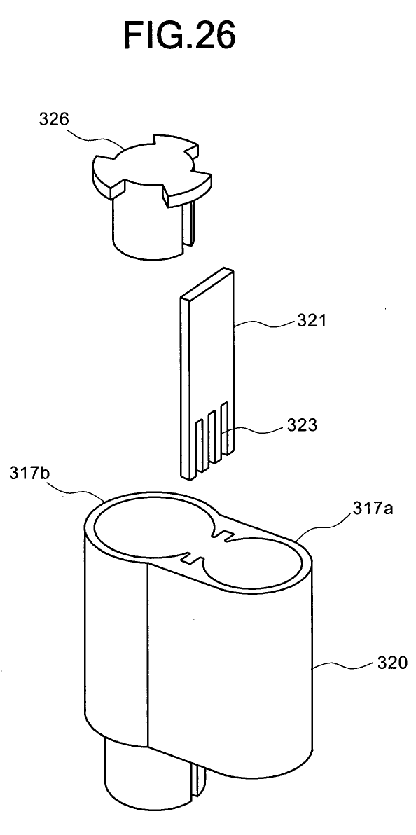

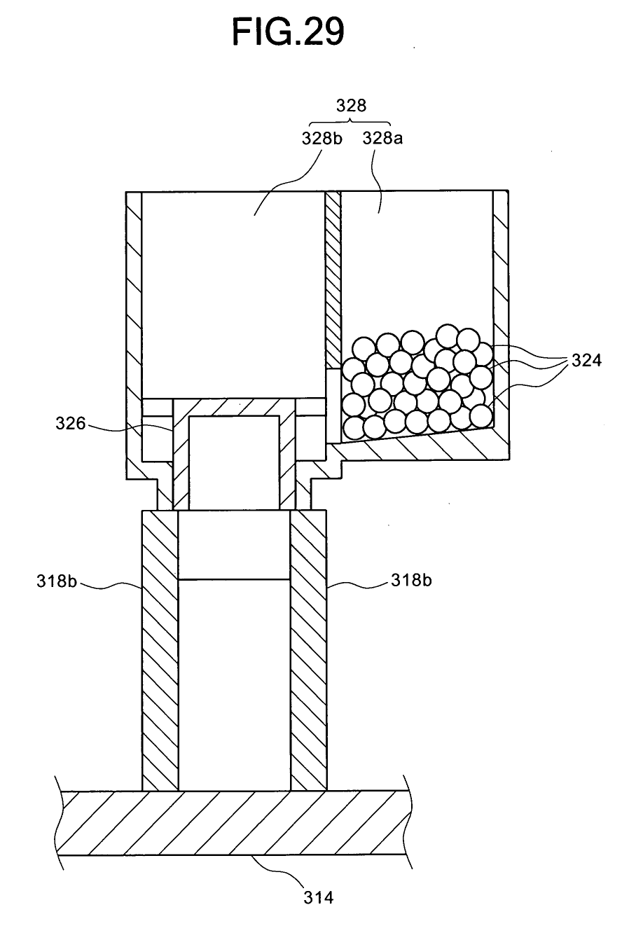

In order to assemble the upper fluid handling section 316 with this construction, as shown in FIG. 26, after the partition plate 321 is arranged between the first and second upper fluid handling divisions 317a and 317b to be fixed to the external wall portion 320, the valve body 326 is inserted into the second upper fluid handling division 317b, and the large number of beads 324 are filled in the first upper fluid handling division 317a. If the upper fluid handling section 316 is thus assembled, the opening formed in the upper end of the first upper fluid handling division 317a can be used as an inlet for injecting a fluid, such as a liquid sample. In addition, a first upper fluid handling chamber 328a (see FIG. 29), which is one of divisional parts of an upper fluid handling chamber 328, is formed in the first upper fluid handling division 317a, and a space serving as a second upper fluid handling chamber 328b, which is the other divisional part of the upper fluid handling chamber 328, is formed above the valve body 326 when the valve body 326 is arranged at the lower end thereof (when the valve is closed). Below the second upper fluid handling chamber 328b, a communication passage for feeding a fluid into the recessed portion 314b of the lower apparatus body 314 is formed when the valve body 326 moves upwards (when the valve is open).

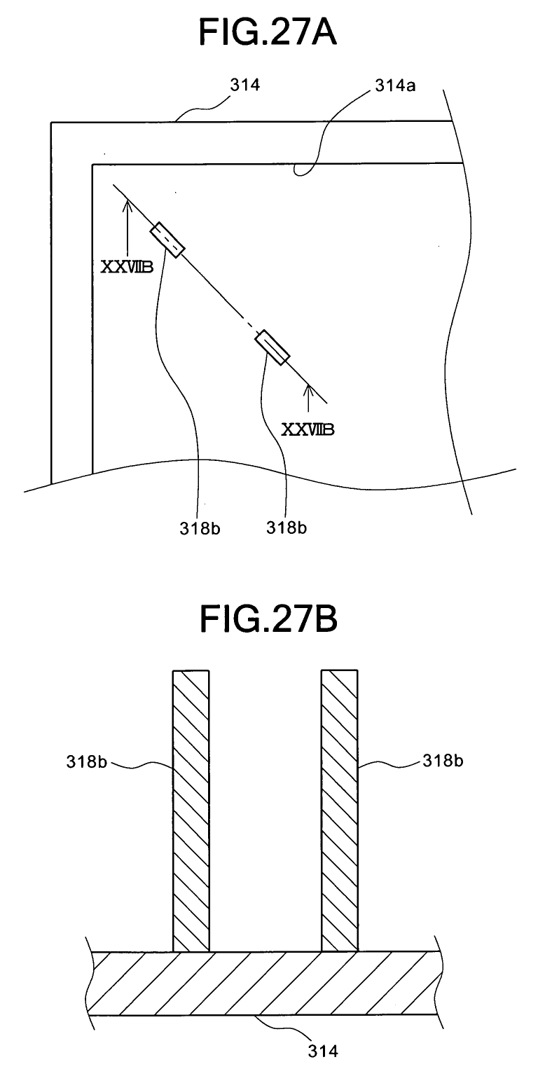

FIGS. 27A and 27B are enlarged views showing a part of the lower apparatus body 314 of the fluid handling apparatus 310 in this preferred embodiment. FIG. 27A is a plan view of a part of the lower apparatus body 314, and FIG. 27B is a sectional view taken along line XXVIIB-XXVIIB of FIG. 27A. As shown in FIGS. 27A and 27B, in this preferred embodiment similar to the third preferred embodiment, a pair of protruding portions 318b extending upwards in vertical directions from the bottom face of the recessed portion 314a of the lower apparatus body 314 are arranged at an interval so as to correspond to the cut-out portions 320d of each of the upper fluid handling sections 316, without forming the external wall portions 118a for defining each of the lower fluid handling sections 118 in the second preferred embodiment. Furthermore, the direction of the width of each of the protruding portions 318a in this preferred embodiment is inclined with respect to the side face of the lower apparatus body 314 unlike the protruding portions 218b in the third preferred embodiment. This corresponds to the fact that each of the upper fluid handling sections 316 is inclined.

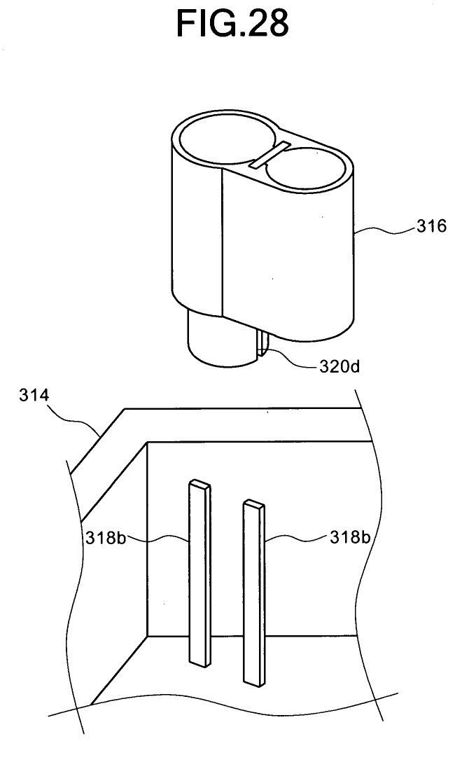

As shown in FIGS. 28 and 29, if the upper apparatus body 312 is mounted on the lower apparatus body 314, the bottom face of the valve seat vertical portion 326c of the valve body 326 of the upper fluid handling section 316 is pushed up by the protruding portions 318b of the lower apparatus body 314, which enter a space defined by the lower vertical wall portion 320c from the cut-out portions 320d of the external wall portion 320 of the upper fluid handling section 316, so that the valve body 326 moves upwards. Then, the bottom face of the valve seat horizontal portion 326a of the valve body 326 leaves the upper face of the horizontal wall portion 320b of the external wall portion 320 of the upper fluid handling section 316 to open the valve, so that a fluid injected into the upper fluid handling chamber 328 (the first and second upper fluid handling chambers 328a and 328b) is fed into the recessed portion 314a of the lower apparatus body 314 via the slits 326e of the valve body 326 (see FIGS. 25A) to be discharged from the outlet 314b.

### Fifth Preferred Embodiment

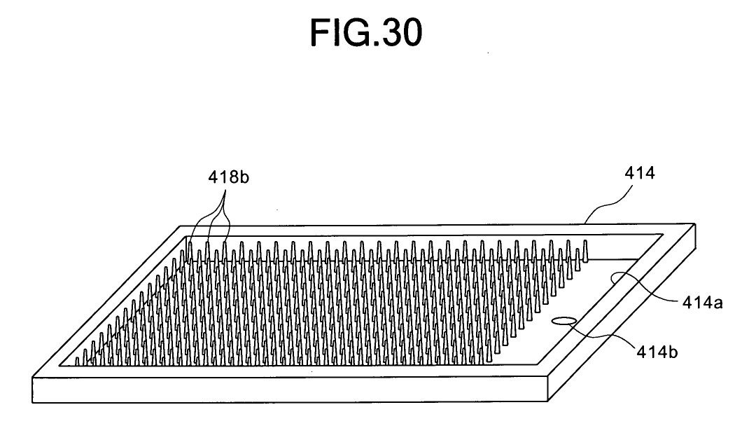

FIGS. 30 through 34 show the fifth preferred embodiment of a fluid handling apparatus according to the present invention. In this preferred embodiment, the fluid handling apparatus 10 in the above described first preferred embodiment is combined with a lower apparatus body 414 used as an exclusive tray for drain.

Similar to the lower apparatus body 14 in the first preferred embodiment, the lower apparatus body 414 comprises a substantially rectangular flat plate member which is made of a resin material, such as polycarbonate (PC) or polymethyl methacrylate (PMMA), or a glass material and which has a thickness of a few millimeters, the length of each side of the flat plate member being in the range of from a few centimeters to over ten centimeters. As shown in FIG. 30, the upper face of the lower apparatus body 414 has a substantially rectangular recessed portion 414a, the bottom face of which has an outlet 414b. The lower apparatus body 414 has a large number of protruding portions 418b which protrude upwards in vertical directions from the bottom face of the recessed portion 414a. Each of the protruding portions 418b is used for pushing up and opening a corresponding one of valve bodies 26 of the upper apparatus body 12 of the fluid handling apparatus 10 in the first preferred embodiment.

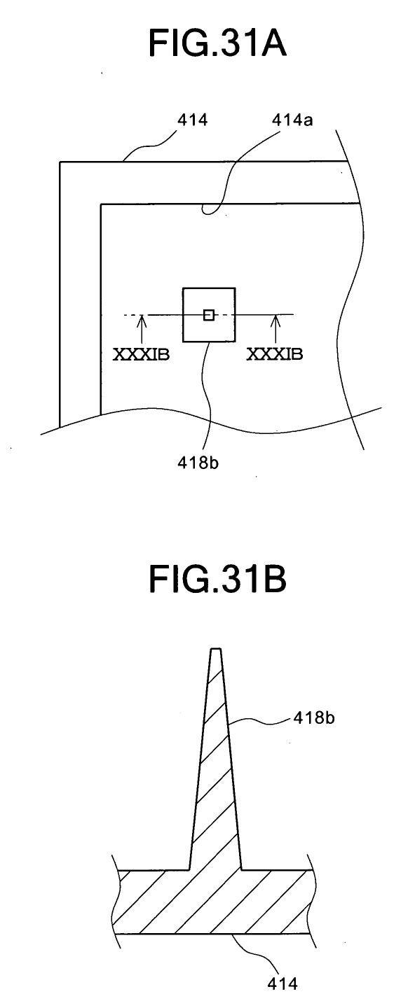

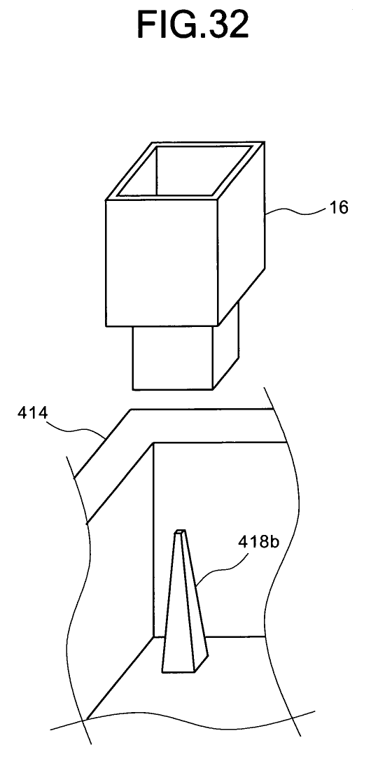

FIGS. 31A and 31B are enlarged views showing a part of the lower apparatus body 414 used as an exclusive tray for drain in the fluid handling apparatus in this preferred embodiment. FIG. 31A is a plan view of a part of the lower apparatus body 414, and FIG. 31B is a sectional view taken along line XXXIB-XXXIB of FIG. 31A. As shown in FIGS. 31A and 31B, protruding portions 418b extending upwards in vertical directions from the bottom face of the recessed portion 414a of the lower apparatus body 414 are arranged at intervals so that each of the protruding portions 418b corresponds to the bottom face of the valve rod portion 26b of the valve body 26 of a corresponding one of the upper fluid handling sections 16, without forming the external wall portions 18a for defining each of the lower fluid handling sections 18 of the lower apparatus body 14.

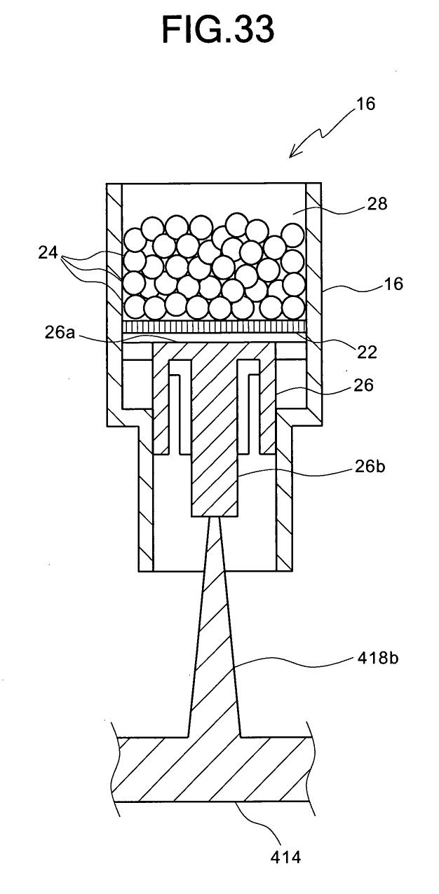

As shown in FIGS. 32 and 33, if the upper apparatus body 12 is mounted on the lower apparatus body 414 serving as an exclusive tray for drain, the bottom face of the valve rod portion 26b of the valve body 26 of the upper fluid handling section 16 is pushed up by the protruding portion 418b of the lower apparatus body 414, so that the valve body 26 moves upwards. Then, the bottom face of the valve seat horizontal portion 26a of the valve body 26 leaves the upper face of the horizontal wall portion 20b of the external wall portion 20 of the upper fluid handling section 16 to open the valve, so that a fluid injected into the upper fluid handling chamber 28 is fed into the recessed portion 414a of the lower apparatus body 414 via the slits 26e of the valve body 26 (see FIGS. 3A and 3B) to be discharged from the outlet 414a.

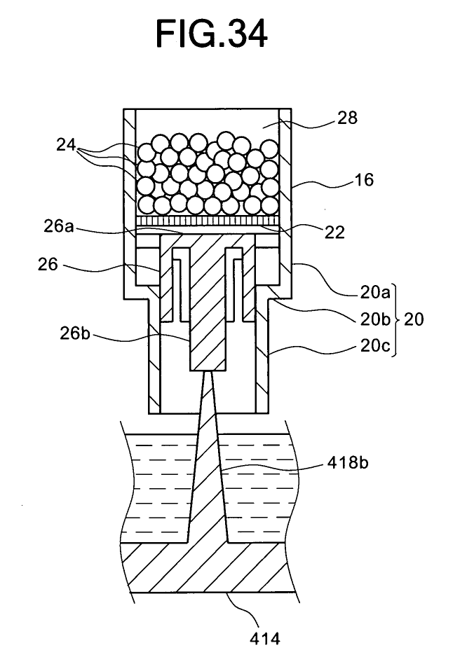

Referring to FIG. 34 and FIGS. 7A through 7E, an example of application of the fluid handling apparatus in this preferred embodiment will be described below.

First, as shown in FIG. 7A, a large number of beads 24 coated with an antibody are filled on the mesh member 22 in each of the upper fluid handling sections 16 of the upper apparatus body 12 of the fluid handling apparatus in this preferred embodiment. Then, as shown in FIG. 7B, an antigen is injected into the upper fluid handling chamber 28 serving as a reaction chamber to allow the antigen to react with the antibody coated on the beads 24 while the valve body 26 of each of the upper fluid handling sections 16 is closed. Then, the upper apparatus body 12 is stacked on the lower apparatus body 414 serving as an exclusive tray for drain. Thus, as shown in FIG. 34, the bottom face of the valve rod portion 26b of the valve body 26 of each of the upper fluid handling sections 16 is pushed up by the protruding portion 418b of the lower apparatus body 414, so that the valve body 26 moves upwards. Then, the bottom face of the valve seat horizontal portion 26a of the valve body 26 leaves the upper face of the horizontal wall portion 20b of the external wall portion 20 of each of the upper fluid handling sections 16 to open the valve, so that the reacted liquid is fed from the upper fluid handling chamber 28 into the recessed portion 414a of the lower apparatus body 414 via the slits 26e of the valve body 26 to be discharged from the outlet 414b. After the reacted liquid is discharged, a washing solution is injected into the upper fluid handling chamber 28 to wash the interior thereof while the valve body 26 of each of the upper fluid handling sections 16 is open.

Then, as shown in FIG. 7B, the upper apparatus body 12 is removed from the lower apparatus body 414, and a biotin labeled antibody is injected into the upper fluid handling chamber 28 to allow a reaction while the valve body 26 of each of the upper fluid handling sections 16 is closed. Then, as shown in FIG. 34, the upper apparatus body 12 is stacked on the lower apparatus body 414 serving as an exclusive tray for drain to open the valve, so that the reacted liquid is fed from the upper fluid handling chamber 28 into the recessed portion 414a of the lower apparatus body 414 via the slits 26e of the valve body 26 to be discharged from the outlet 414b. After the reacted liquid is discharged, a washing solution is injected into the upper fluid handling chamber 28 to wash the interior thereof while the valve body 26 of each of the upper fluid handling sections 16 is open.

Then, as shown in FIG. 7B, the upper apparatus body 12 is removed from the lower apparatus body 414, and a streptoavidin-enzyme is injected into the upper fluid handling chamber 28 to allow a reaction while the valve body 26 of each of the upper fluid handling sections 16 is closed. Then, as shown in FIG. 34, the upper apparatus body 12 is stacked on the lower apparatus body 414 serving as an exclusive tray for drain to open the valve, so that the reacted liquid is fed from the upper fluid handling chamber 28 into the recessed portion 414a of the lower apparatus body 414 via the slits 26e of the valve body 26 to be discharged from the outlet 414b. After the reacted liquid is discharged, a washing solution is injected into the upper fluid handling chamber 28 to wash the interior thereof while the valve body 26 of each of the upper fluid handling sections 16 is open.

Then, as shown in FIG. 7B, the upper apparatus body 12 is removed from the lower apparatus body 414, and a substrate is injected into the upper fluid handling chamber 28 to allow a reaction while the valve body 26 of each of the upper fluid handling sections 16 is closed. Then, if the upper apparatus body 12 is stacked on the lower apparatus body 14, the lower vertical wall portion 20c of the external wall portion 20 of each of the upper fluid handling sections 16 of the upper apparatus body 12 is inserted into a corresponding one of the lower fluid handling sections 18 of the lower apparatus body 14, and the horizontal wall portion 20b of the external wall portion 20 is supported on the corresponding one of the lower fluid handling sections 18, as shown in FIG. 7C. At this time, the bottom face of the valve rod portion 26b of the valve body 26 of each of the upper fluid handling sections 16 is pushed up by the protruding portion 18b of the corresponding one of the lower fluid handling sections 18, so that the valve body 26 moves upwards. Then, the bottom face of the valve seat horizontal portion 26a of the valve body 26 leaves the upper face of the horizontal wall portion 20b of the external wall portion 20 of each of the upper fluid handling sections 16 to open the valve, so that the reacted liquid is discharged from the upper fluid handling chamber 28 into the interior of the corresponding one of the lower fluid handling sections 18 (the lower fluid handling chamber 30) via the slits 26e of the valve body 26. After the reacted solution emitting fluorescence is thus recovered in the lower fluid handling chamber 30, the upper apparatus body 12 is removed from the lower apparatus body 14 as shown in FIG. 7D, and a reaction stop solution is added into the lower fluid handling chamber 30 of each of the lower fluid handling sections 18 of the lower apparatus body 14 by means of a pipette 32 to stop the reaction, so that it is possible to measure fluorescence in a state shown in FIG. 7E.

### Sixth Preferred Embodiment

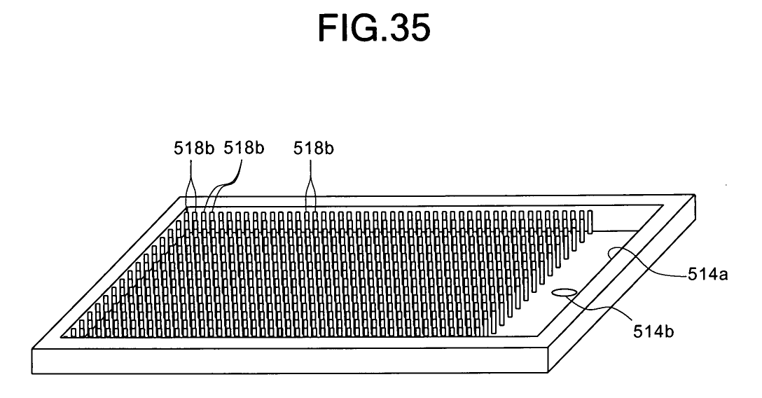

FIGS. 35 through 39 show the sixth preferred embodiment of a fluid handling apparatus according to the present invention. In this preferred embodiment, the fluid handling apparatus 110 in the above described second preferred embodiment is combined with a lower apparatus body 514 used as an exclusive tray for drain.

Similar to the lower apparatus body 114 in the second preferred embodiment, the lower apparatus body 514 comprises a substantially rectangular flat plate member which is made of a resin material, such as polycarbonate (PC) or polymethyl methacrylate (PMMA), or a glass material and which has a thickness of a few millimeters, the length of each side of the flat plate member being in the range of from a few centimeters to over ten centimeters. As shown in FIG. 35, the upper face of the lower apparatus body 514 has a substantially rectangular recessed portion 514a, the bottom face of which has an outlet 514b. The lower apparatus body 514 has a large number of pairs of protruding portions 518b which protrude upwards in vertical directions from the bottom face of the recessed portion 514a. Each pair of protruding portions 518b are used for pushing up and opening each of valve bodies 126 of the upper apparatus body 112 of the fluid handling apparatus 110 in the second preferred embodiment.

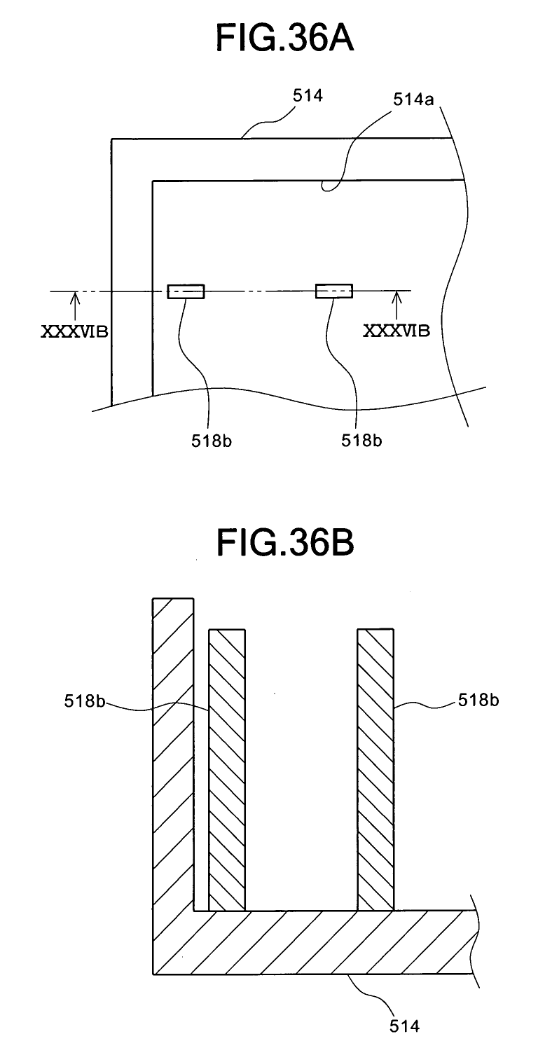

FIGS. 36A and 36B are enlarged views showing a part of the lower apparatus body 514 used as an exclusive tray for drain in the fluid handling apparatus in this preferred embodiment. FIG. 36A is a plan view of a part of the lower apparatus body 514, and FIG. 36B is a sectional view taken along line XXXVIB-XXXVIB of FIG. 36A. As shown in FIGS. 36A and 36B, a pair of protruding portions 518b extending upwards in vertical directions from the bottom face of the recessed portion 514a of the lower apparatus body 514 are arranged at an interval so as to correspond to the cut-out portions 120d of each of the upper fluid handling sections 116, without forming the external wall portions 118a for defining each of the lower fluid handling sections 118 of the lower apparatus body 114.

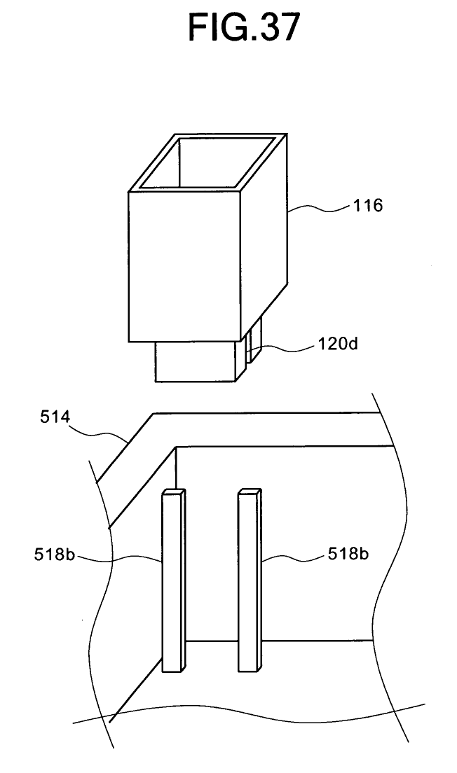

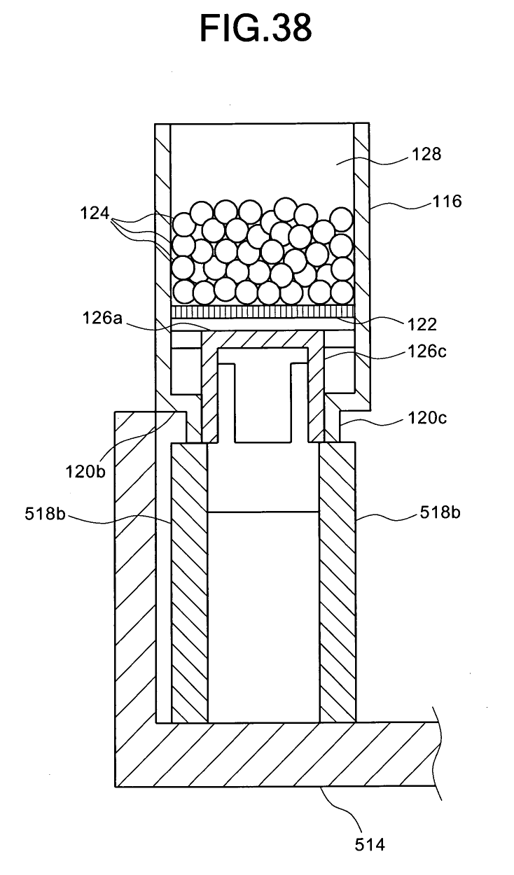

As shown in FIGS. 37 and 38, if the upper apparatus body 12 is mounted on the lower apparatus body 514 serving as an exclusive tray for drain, the bottom face of the valve seat vertical portion 126c of the valve body 126 of the upper fluid handling section 116 is pushed up by the protruding portions 518b of the lower apparatus body 514, which enter a space defined by the lower vertical wall portion 120c from the cut-out portions 120d of the external wall portion 120 of the upper fluid handling section 116, so that the valve body 126 moves upwards. Then, the bottom face of the valve seat horizontal portion 126a of the valve body 126 leaves the upper face of the horizontal wall portion 120b of the external wall portion 120 of the upper fluid handling section 116 to open the valve, so that a fluid injected into the upper fluid handling chamber 128 is fed into the recessed portion 514a of the lower apparatus body 514 via the slits 126e of the valve body 126 (see FIGS. 10A and 10B) to be discharged from the outlet 414b.

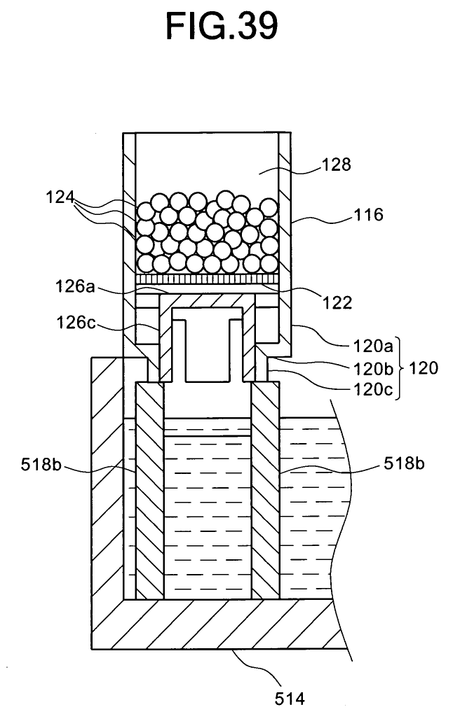

Referring to FIG. 39 and FIGS. 15A through 15E, an example of application of the fluid handling apparatus in this preferred embodiment will be described below.

First, as shown in FIG. 15A, a large number of beads 124 coated with an antibody are filled on the mesh member 122 in each of the upper fluid handling sections 116 of the upper apparatus body 112 of the fluid handling apparatus in this preferred embodiment. Then, as shown in FIG. 15B, an antigen is injected into the upper fluid handling chamber 128 serving as a reaction chamber to allow the antigen to react with the antibody coated on the beads 124 while the valve body 126 of each of the upper fluid handling sections 116 is closed. Then, the upper apparatus body 112 is stacked on the lower apparatus body 514 serving as an exclusive tray for drain. Thus, as shown in FIG. 39, the bottom face of the valve seat vertical portion 126c of the valve body 126 of each of the upper fluid handling sections 116 is pushed up by the protruding portions 518b of the lower apparatus body 514, which enter the space defined by the lower vertical wall portion 120c from the cut-out portions 120d of the external wall portion 120 of the upper fluid handling section 116, so that the valve body 126 moves upwards. Then, the bottom face of the valve seat horizontal portion 126a of the valve body 126 leaves the upper face of the horizontal wall portion 120b of the external wall portion 120 of the upper fluid handling section 116 to open the valve, so that the reacted liquid is fed from the upper fluid handling chamber 128 into the recessed portion 514a of the lower apparatus body 514 via the slits 126e of the valve body 126 to be discharged from the outlet 514b. After the reacted liquid is discharged, a washing solution is injected into the upper fluid handling chamber 128 to wash the interior thereof while the valve body 126 of each of the upper fluid handling sections 116 is open.

Then, as shown in FIG. 15B, the upper apparatus body 112 is removed from the lower apparatus body 514, and a biotin labeled antibody is injected into the upper fluid handling chamber 128 to allow a reaction while the valve body 126 of each of the upper fluid handling sections 116 is closed. Then, as shown in FIG. 39, the upper apparatus body 112 is stacked on the lower apparatus body 514 serving as an exclusive tray for drain to open the valve, so that the reacted liquid is fed from the upper fluid handling chamber 128 into the recessed portion 514a of the lower apparatus body 514 via the slits 126e of the valve body 126 to be discharged from the outlet 514b. After the reacted liquid is discharged, a washing solution is injected into the upper fluid handling chamber 128 to wash the interior thereof while the valve body 126 of each of the upper fluid handling sections 116 is open.

Then, as shown in FIG. 15B, the upper apparatus body 112 is removed from the lower apparatus body 514, and a streptoavidin-enzyme is injected into the upper fluid handling chamber 128 to allow a reaction while the valve body 126 of each of the upper fluid handling sections 116 is closed. Then, as shown in FIG. 39, the upper apparatus body 112 is stacked on the lower apparatus body 514 serving as an exclusive tray for drain to open the valve, so that the reacted liquid is fed from the upper fluid handling chamber 128 into the recessed portion 514a of the lower apparatus body 514 via the slits 126e of the valve body 126 to be discharged from the outlet 514b. After the reacted liquid is discharged, a washing solution is injected into the upper fluid handling chamber 128 to wash the interior thereof while the valve body 126 of each of the upper fluid handling sections 116 is open.

Then, as shown in FIG. 15B, the upper apparatus body 112 is removed from the lower apparatus body 514, and a substrate is injected into the upper fluid handling chamber 128 to allow a reaction while the valve body 126 of each of the upper fluid handling sections 116 is closed. Then, if the upper apparatus body 112 is stacked on the lower apparatus body 114, the lower vertical wall portion 120c of the external wall portion 120 of each of the upper fluid handling sections 116 of the upper apparatus body 112 is inserted into a corresponding one of the lower fluid handling sections 118 of the lower apparatus body 114, and the horizontal wall portion 120b of the external wall portion 120 is supported on the corresponding one of the lower fluid handling sections 118, as shown in FIG. 15C. At this time, the bottom face of the valve seat vertical portion 126c of the valve body 126 of each of the upper fluid handling sections 116 is pushed up by the protruding portion 118b of the corresponding one of the lower fluid handling sections 118, so that the valve body 126 moves upwards. Then, the bottom face of the valve seat horizontal portion 126a of the valve body 126 leaves the upper face of the horizontal wall portion 120b of the external wall portion 120 of each of the upper fluid handling sections 116 to open the valve, so that the reacted liquid is discharged from the upper fluid handling chamber 128 into the interior of the corresponding one of the lower fluid handling sections 118 (the lower fluid handling chamber 130) via the slits 126e of the valve body 126. After the reacted solution emitting fluorescence is thus recovered in the lower fluid handling chamber 130, the upper apparatus body 112 is removed from the lower apparatus body 114 as shown in FIG. 15D, and a reaction stop solution is added into the lower fluid handling chamber 130 of each of the lower fluid handling sections 118 of the lower apparatus body 114 by means of a pipette 132 to stop the reaction, so that it is possible to measure fluorescence in a state shown in FIG. 15E.

As described above, in the fluid handling apparatus 10, 110 in the first and second preferred embodiments, if only the upper fluid handling sections 16, 116 are mounted on the lower fluid handling sections 18, 118, the valve bodies 26, 126 are open, so that fluid in the upper fluid handling chambers 28, 128 can be discharged into the lower fluid handling chambers 20, 130. Therefore, fluid can be discharged with a simple structure, and the fluid handling apparatus 10, 110 can be applied to the absorbance measuring method if the bottom portions of the lower fluid handling chambers 30, 130 are made of a transparent member.

In the fluid handling apparatus 210, 310 in the third and fourth preferred embodiments, if only the upper apparatus body 212, 312 is mounted on the lower apparatus body 214, 314, the valve bodies 226, 326 are open, so that fluid in the upper fluid handling chambers 228, 328 can be discharged into the recessed portion 214a, 314a of the lower apparatus body 214, 314. Therefore, fluid can be discharged with a simple structure, and the fluid handling apparatus 210, 310 can be applied to the absorbance measuring method if the valve bodies 226, 326 are made of a transparent member.

If the fluid handling apparatus 10 or 110 in the first or second preferred embodiment is combined with the lower apparatus body 414, 514 serving as an exclusive tray for drain as the fifth and sixth preferred embodiments, it is possible to discharge fluid with a simple structure, and the apparatus can be applied to the absorbance measuring method if the bottom portions of the lower fluid handling chambers 30 or 130 are made of a transparent member.

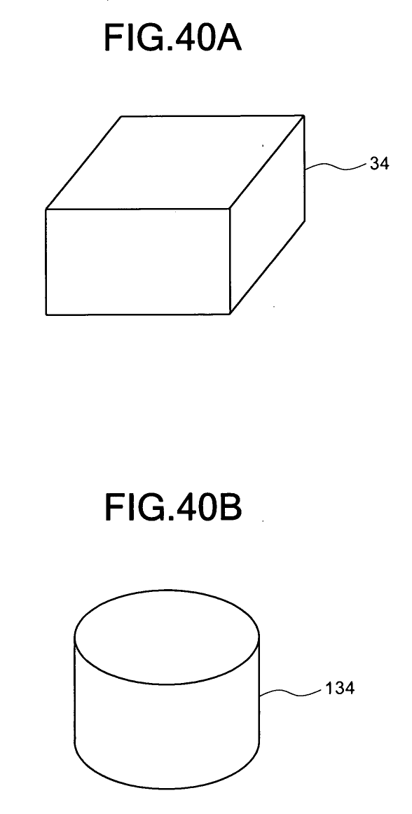

In the fluid handling apparatus in the first through sixth preferred embodiments, the large number of beads 24, 124, 224, 324 are filled in the upper fluid handling chambers 28, 128, 228, 328 to increase the surface area of the inner surface of each of the passages in the upper fluid handling chambers 28, 128, 228, 328. Therefore, when the fluid handling apparatus is used as a sample analyzing apparatus, if the surface of each of the beads 24, 124, 224, 324 is utilized as a supporting surface (a reaction surface) for a capturing material, it is possible to increase the surface area of the supporting surface (the reaction surface) for the capturing material to increase the contact area with fluid. If liquid is allowed to continuously flow on the large reaction surface, it is possible to enhance the efficiency of reaction, and it is possible to shorten the reaction time and improve the sensitivity of measurement. Furthermore, in place of the beads 24, 124, 224, 324 used for increasing the surface area of the inner surface of each of the passages in the upper fluid handling chambers 28, 128, 228, 328, a single water absorptive member 34 or 134 having a substantially rectangular parallelopiped or cylindrical shape which has the same planar shape as the upper fluid handling chamber 28, 128 or the first upper fluid handling chamber 228a, 328a, as shown in FIG. 40A or 40B.

In the fluid handling apparatus in the first through three, fifth and sixth preferred embodiments, if a substantially circular opening is formed in place of the substantially square opening of the horizontal wall portion 20b, 120b, 220b of the upper fluid handling sections 16, 116, 216 and if a substantially cylindrical wall portion is formed in place of the lower vertical wall portion 20c, 120c, 220c extending downwards in vertical directions from the opening end portion of the opening of the horizontal wall 20b, 120b, 220b, a spherical valve body, which can be housed in the upper fluid handling chamber 28, 128 or second upper fluid handling chamber 228b, 328b and which has a larger diameter than the diameter of the substantially circular opening of the horizontal wall portion 20b, 120b, 220b, 320b, may be used in place of the valve body 26, 126, 226, 326 for opening and closing the outlet for discharging a fluid downward from the upper fluid-handling chamber 28, 128, 228, 328, in the fluid handling apparatus in the first through sixth preferred embodiments.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

What is claimed is:

1. A fluid handling apparatus comprising an upper apparatus body on which a plurality of upper fluid handling sections are arrayed, and a lower apparatus body for mounting thereon the upper apparatus body, each of the upper fluid handling sections comprising:
an inlet for injecting a fluid;
an upper fluid handling chamber for housing therein the fluid injected from the inlet;
a surface-area increasing means, arranged in the upper fluid handling chamber, for increasing an area of a contact surface with the fluid in the upper fluid handling chamber;
an outlet for discharging the fluid downwards from the upper fluid handling chamber; and
a valve body for opening and closing the outlet,
wherein said lower apparatus body has a lower fluid housing section for housing therein the fluid discharged from the upper fluid handling chamber, and the valve body of each of the upper fluid handling sections is open when the upper apparatus body is mounted on the lower apparatus body.

2. A fluid handling apparatus as set forth in claim 1, wherein said lower apparatus body has a plurality of protruding portions which protrude upwards from the bottom face of the lower fluid housing section thereof and which are arranged so as to correspond to the upper fluid handling sections, and said valve body is pushed up by a corresponding one of said protruding portions when said upper apparatus body is mounted on said lower apparatus body.

3. A fluid handling apparatus as set forth in claim 1, wherein each of said upper fluid handling sections has a holding member having an opening for inhibiting said surface-area increasing means from passing therethrough and for allowing the fluid to pass therethrough, said holding member being arranged between said surface-area increasing means and said valve body.

4. A fluid handling apparatus as set forth in claim 3, wherein said upper fluid handling chamber of each of said upper fluid handling sections is divided into a first upper fluid handling chamber, which houses therein said surface-area increasing means, and a second upper fluid handling chamber in which said valve body is mounted, said holding member being arranged between said first and second upper fluid handling chambers.

5. A fluid handling apparatus as set forth in claim 1, wherein said lower fluid handling section of said lower apparatus body has a plurality of lower fluid handling chambers which are separated from each other so that each of said lower fluid handling chambers corresponds to a corresponding one of said upper fluid handling chambers of said upper fluid handling sections.

6. A fluid handling apparatus as set forth in claim 3, wherein said lower fluid handling section of said lower apparatus body has a plurality of lower fluid handling chambers which are separated from each other so that each of said lower fluid handling chambers corresponds to a corresponding one of said upper fluid handling chambers of said upper fluid handling sections, and said holding member is arranged above said valve body to support thereon said surface-area increasing means.

7. A fluid handling apparatus as set forth in claim 1, wherein an outlet for discharging the fluid is formed in a bottom face of said lower fluid housing section of said lower apparatus body.

8. A fluid handling apparatus as set forth in claim 1, wherein said valve body is made of a transparent member.

9. A fluid handling apparatus as set forth in claim 1, wherein said surface-area increasing means comprises a plurality of fine particles fine particles.

10. A fluid handling apparatus as set forth in claim 1, wherein said surface-area increasing means comprises a single member.
